(19) United States
(12) Patent Application Publication
(10) Pub. No.: US 2025/0270182 A1
(43) Pub. Date: Aug. 28, 2025

(54) Composition Comprising an Antimicrobial Agent and an Alkyl Ketal Ester Compound

(71) Applicant: Symrise AG, Holzminden (DE)

(72) Inventors: Steffen NORDZIEKE, Göttingen (DE); Sabine LANGE, Holzminden (DE); Ricarda KRAELING, Holzminden (DE); Imke MEYER, Bodenwerder (DE); Maik MASCHER, Emmerthal (DE)

(21) Appl. No.: 18/858,297

(22) PCT Filed: Apr. 22, 2022
(86) PCT No.: PCT/EP2022/060783

§ 371 Date: Oct. 18, 2024

(51) Int. Cl. C07D 319/06; A61K 8/49; A61K 31/357; A61Q 17/00

(52) U.S. Cl. CPC C07D 319/06; A61K 8/4973; A61K 8/498; A61K 31/357; A61Q 17/005

(57) ABSTRACT

The present invention refers to a composition comprising or consisting of a synergistic combination of an effective amount of an antimicrobial agent and an effective amount of an alkyl ketal ester compound. In a further aspect the present invention relates to novel antimicrobials. Furthermore, the present invention relates to food, cosmetic or pharmaceutical preparations comprising said composition. Additionally, the present invention refers to the use of said composition or of said novel antimicrobials for suppressing or inhibiting microorganism growth in food, a cosmetic or a pharmaceutical preparation. Additionally, the present invention relates to the use of an alkyl ketal ester compound, especially ethyl propylene glycol acetal levulinate and/or ethyl glycerine acetal levulinate and/or butyl-3-(2,4-dimethyl-1,3-dioxolan-2-yl-)propanoate for boosting the efficacy of an antimicrobial agent. Finally, the present invention relates to a method for suppressing or inhibiting of microorganism growth in food, cosmetic or a pharmaceutical preparations or home care products by said composition or by said novel antimicrobials.

### TECHNICAL FIELD

The present invention refers to a composition comprising or consisting of a synergistic combination of an effective amount of an antimicrobial agent and an effective amount of an alkyl ketal ester compound. In a further aspect the present invention relates to novel antimicrobials. Furthermore, the present invention relates to food, cosmetic or pharmaceutical preparations or home care products comprising said composition. Additionally, the present invention refers to the use of said composition or of said novel antimicrobials for suppressing or inhibiting microorganism growth in food, cosmetic or pharmaceutical preparations or home care products. Additionally, the present invention relates to the use of an alkyl ketal ester compound, especially ethyl propylene glycol acetal levulinate and/or ethyl glycerine acetal levulinate for boosting the efficacy of an antimicrobial agent. Finally, the present invention relates to a method for suppressing or inhibiting of microorganism growth in food, cosmetic or pharmaceutical preparations or home care products by said composition or by said novel antimicrobials.

### BACKGROUND ART

Food, cosmetics, pharmaceuticals or home care products provide an optimal medium for microbial contaminants: With proteins, sugar, vitamins, oils and water, they contain everything microorganisms need to grow. In particular, cosmetic or pharmaceutical formulations with a higher water content and/or great surfaces, such as emulsions or wet-wipes, or formulations with natural ingredients, which are contaminated with bacteria innately, are susceptible against microbial growth. The neutral pH-value and the storage in a warm and humid bathroom contribute to an ideal climate for bacteria and moulds. Via hand and mouth, a lot of microorganisms get into the product. Sometimes the product is already contaminated during the production process, for example from contaminated raw materials. Most of the microorganisms are harmless to the consumer. However, microbial contaminants can cause dangerous infections. In addition, some moulds and bacteria produce toxins which can cause allergic reactions and skin irritations.

In order to minimize the microbial contamination, preservatives are used. Preservatives are essential in the production of cosmetics, because they kill or inhibit the growth of microorganisms. Without sufficient preservation, this in turn can lead to product spoilage, which in cosmetic products may manifest as changes in smell, discoloration, mould growth, gas formation, the separation of emulsions or changes in viscosity, rendering the product unacceptable to the consumer.

Preservatives, especially antimicrobial agents, are therefore very important to keep cosmetics from spoiling and to inhibit the growth of potentially dangerous microorganisms. However, not all substances that can be used as a preservative are harmless to the consumer. Parabens for example have a hormonal effect; benzoic acid can cause pseudo allergic reactions. The German Cosmetics Regulation lists all preservatives allowed in cosmetic products.

In addition, there are a couple of natural materials that contain substances that are said to have an antimicrobial effect. These include for example propolis, cinnamon bark, clove oil, allspice oil, nutmeg oil, ylang ylang, rose oil and thyme. However, these substances have not been adequately researched for use as a preservative in the cosmetics industry.

At present, there are no legally binding limit values for germ contents in cosmetics. According to a recommendation of the Scientific Committee on Consumer Safety of the European Commission, cosmetics should contain no more than 100 or 1.000 colony-forming units per gram, depending on the type of product. Certain pathogens such as Staphylococcus or E. coli are not allowed to be detectable at all.

Thus, in the cosmetic and pharmaceutical industry and also in the food industry or home care business/market there is an ongoing need for agents with antimicrobial properties for product protection.

It is true that a multiplicity of antimicrobial active substances are already used in the technical fields concerned, but alternatives continue to be sought in order to be able to carry out targeted special treatments and/or reduce side effects. However, in this context when searching for alternative agents having an antimicrobial and in particular a preservative action it must be taken into account that the substances used in the cosmetic, pharmaceutical and/or food sector must be
toxicologically acceptable;
well tolerated by the skin;
stable (especially in the customary cosmetic and/or pharmaceutical formulations);
substantially and preferably completely odourless; and
able to be prepared inexpensively (i.e., using standard methods and/or starting from standard precursors) and of natural origin or based on green synthesis.

The search for suitable (active) substances that possess one or more of the said properties to an adequate extent is made more difficult for those skilled in the art because there is no clear dependence between the chemical structure of a substance, on the one hand, and its biological activity towards specific microorganisms (germs) and its stability, on the other hand. Furthermore, there is no predictable relationship between the antimicrobial action, toxicological acceptability, tolerance by the skin and the stability of a substance.

Furthermore, the antimicrobial agent should have antimicrobial activity characteristics, which fulfil diverse criteria. They should
provide a broad-spectrum antimicrobial activity against gram positive and gram-negative bacteria, yeast, mould and fungi;
show a particularly strong activity against Candida and Aspergillus; and
be active in different cosmetic or pharmaceutical formulations, in particular at different pH values.

The addition of biocides, especially classical preservative agents like formaldehyde donors, according to biocide regulation is increasingly undesired, in particular with regard to natural cosmetics.

Sterilisation of the formulation is less desired due to a possible degradation of ingredients of the formulation on heat treatment and additional process costs involved.

Thus, there is still an ongoing need to provide novel substances or compositions that fulfil the above requirements and which are microbial stable during shelf life. The cosmetic or pharmaceutical industry but also the food industry and home care business are permanently searching for ingredients which can improve these aspects. In particular, there is continued interest in the market to improve both the potential and the range of efficiency of such antimicrobials, either by achieving a higher performance of an antimicrobial with the same amounts, or, vice versa, by achieving the same performance with lower amounts of an antimicrobial, so that the overall content of antimicrobials can be reduced in the ready-for-use formulation.

It is therefore an object of the present invention to provide a composition, which develop a synergistic action against a multiplicity of bacteria, yeast, mould and fungi, in particular in food, cosmetic or pharmaceutical preparations or household products, and its use by which the activity or growth of microorganism can be suppressed or inhibited.

Furthermore, it is an object of the present invention, to provide novel antimicrobial compounds.

Furthermore, it is an object of the present invention, to provide a food, cosmetic or pharmaceutical preparations or home care products comprising said composition or a novel antimicrobial according to the present invention.

Furthermore, it is an object of the present invention, to provide a substance, by which the antimicrobial efficacy of an antimicrobial agent can be boosted.

Furthermore, it is an object of the present invention, to provide a method for suppressing or inhibiting of microorganisms' growth in food, cosmetic or pharmaceutical preparations or home care products.

The invention is based on the surprising finding that the concomitantly use of an effective amount of an alkyl ketal ester compound as defined herein, especially of ethyl propylene glycol acetal levulinate and ethyl glycerine acetal levulinate, with an antimicrobial agent result in a synergistic antimicrobial efficacy action against a multiplicity of microorganisms such as bacteria, yeast, mould and fungi. The use of such a composition in food, cosmetic or pharmaceutic preparations or home care products in turn results in microbial stable formulations which can be stored. Surprisingly, the synergistic antimicrobial efficacy is directed against species of the genus Staphylococcus, Candida, Aspergillus, Pseudomonas and Escherichia, and combinations thereof.

Additionally, it surprisingly turned out, that certain alkyl ketal ester compounds as defined herein have antimicrobial efficacy against species of the genus Staphylococcus, Candida, Aspergillus, Pseudomonas and Escherichia, and combinations thereof.

### SUMMARY OF THE INVENTION

In order to accomplish the above problem, the present invention provides in a first aspect a composition, comprising or consisting of
(a) an effective amount of at least one antimicrobial agent,
(b) an effective amount of an alkyl ketal ester compound represented by the general formula (I)

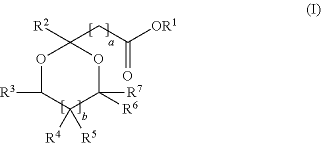

wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof; and
(c) optionally at least one active substance for food, a cosmetic or pharmaceutical composition or a home care product and/or an additive.

In a second aspect, the present invention provides for an antimicrobial compound represented by the general formula (I)

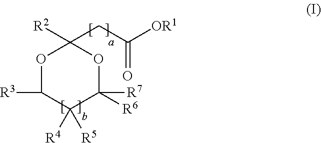

wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof.

In a further aspect, the present invention provides for food, cosmetic or pharmaceutical preparations or home care products comprising said antimicrobial composition or said novel antimicrobial according to the present invention.

In a further aspect, the present invention provides for the use of said antimicrobial composition or said novel antimicrobial according to the present for suppressing or inhibiting microorganism growth in food, a cosmetic or pharmaceutical preparation.

In a still further aspect, the present invention provides for the use of an alkyl ketal ester compound as defined herein for boosting the efficacy of an antimicrobial agent.

In a final aspect, the present invention provides a method for suppressing or inhibiting of microorganism growth in food, cosmetic or pharmaceutical preparations or home care products by the antimicrobial composition or an antimicrobial according to the present invention.

The present invention is specified in the appended claims. The invention itself, and its preferred variants, other objects and advantages, are however also apparent from the following detailed description in conjunction with the accompanying examples and figures.

### DETAILED DESCRIPTION OF THE INVENTION

In a first aspect, the present invention relates to a composition, comprising or consisting of:
(a) an effective amount of at least one antimicrobial agent;
(b) an effective amount of an alkyl ketal ester compound represented by the general formula (I)

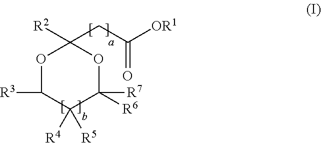

wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof; and
(c) optionally at least one active substance for food, a cosmetic or pharmaceutical composition or a home care product and/or an additive.

The term “comprising” means that the named components in the composition are essential, but other components may be added and is still embraced by the present invention.

The term “consisting of” as used according to the present invention means that the total amount of components (a) to (c) adds up to 100% by weight, based on the total weight of the composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

The term “at least one . . . ” means that the composition according to the present invention can comprise either one or a mixture of two, three, four, five, six or even more different of the respective components following said term.

The term “optionally” means that the subsequently described component may but need not to be present in the composition, and that the description includes variants, where the compound is included or variants, where the compound is absent.

The term “an effective amount of . . . ” in the context of the present invention means the amount of a compound that is sufficient to provide the desired effect, such as antimicrobial effect, synergistic effect, etc.

As used herein, the term “alkyl” or “alkyl group” refers to saturated hydrocarbons having one or more carbon atoms, including straight-chain alkyl groups (e.g. methyl, ethyl, propyl, butyl, pentyl, hexyl, heptyl, octyl, nonyl, decyl, undecyl, dodecyl, etc.), cyclic alkyl groups (e.g. cyclopropyl, cyclobutyl, cyclopentyl, cyclohexyl, cycloheptyl, cyclooctyl, etc.), branched-chain alkyl groups (e.g. isopropyl, tert-butyl, sec-butyl, isobutyl, etc.) and alkyl-substituted alkyl groups (e.g. alkyl-substituted cycloalkyl groups and cycloalkyl-substituted alkyl groups).

Preferred alkyl groups comprise C1 to C6 alkyl, comprising methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl und 1-ethyl-2-methylpropyl.

Unless otherwise specified, the term “alkyl” includes both “unsubstituted alkyls” and “substituted alkyls”.

As used herein, the term “substituted alkyls” refers to alkyl groups having substituents replacing one or more hydrogen(s) on one or more carbon atoms of the hydrocarbon backbone. Such substituents may include, for example, OH, halogeno (Cl, Br, I), alkenyl, alkynyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group.

As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

In a preferred variant, the alkyl groups are unsubstituted.

Alkenyl groups or alkenes are straight chain, branched, or cyclic alkyl groups having two to about 12 carbon atoms, and further including at least one double bond. In some embodiments, alkenyl groups have from 2 to about 10 carbon atoms, or typically, from 2 to 5 carbon atoms.

Unless otherwise specified, the term “alkenyl” includes both “unsubstituted alkenyls” and “substituted alkenyls”.

Alkenyl groups may be substituted similarly to alkyl groups as defined above.

In a preferred variant, the alkenyl groups are unsubstituted.

As used herein, the terms “alkylene”, cycloalkylene”, alkynylene, and alkenylene”, alone or as part of another substituent, refer to a divalent radical derived from an alkyl, cycloalkyl, or alkenyl group, respectively, as exemplified by —CH2CH2CH2-.

The component (a) in the composition according to the first aspect of the present invention relates to an antimicrobial agent or compound, which is commonly used in food and in many cosmetic preparations, in particular skincare, haircare or body care, or in pharmaceutical preparations.

The term “antimicrobial agent” or “antimicrobial compound” in the context of the present invention refers to a group of substances, in particular to an agent that kills microorganisms or stops or inhibits their growth. Antimicrobial agents can be grouped according to the microorganisms they act primarily against. For example, antibiotics are used against bacteria, antifungals are used against fungi, antiprotozoals are used against protozoans, and antivirals are used against virus. They can also be classified according to their function. Agents that kill microbes are biocidal or microbicidal, while those that merely inhibit their growth are called biostatic.

The antimicrobial agent according to the present invention act primarily against microorganisms, in particular bacteria, yeast and/or fungi. Specified microorganisms are aerobic mesophilic bacteria or yeast or fungi undesirable in a cosmetic product that may be harmful for human health or as an indication of hygienic failure in the manufacturing process. Microorganisms considered as specified microorganisms according to the present invention are of the genus Pseudomonas (bacterium), Staphylococcus (bacterium), Escherichia (bacterium), Candida (yeast) and Aspergillus (fungi), and combinations thereof.

More preferably, the microorganisms are selected from the group consisting of Pseudomonas aeruginosa, Staphylococcus aureus, Escherichia coli, Candida albicans and Aspergillus brasiliensis, and combinations thereof.

The composition according to the first aspect of the present invention encompasses at least one antimicrobial active agent selected from the group consisting of o-Cymen-5-ol, Isopropylparaben, Capryloyl Glycine, Phenylpropanol, Tropolone, PCA Ethyl Cocoyl Arginate, 2-Methyl 5-Cyclohexylpentanol, Phenoxyethanol, Disodium EDTA, Methylparaben and its salts, Caprylhydroxamic Acid, Sodium Benzoate, Benzyl Alcohol, Potassium Sorbate, Benzyl Salicylate, Methylbenzyl Alcohol, Propylparaben, Methylchloroisothiazolinone, Methylisothiazolinone, Ethylhexylglycerin, Butylparaben, Ethylparaben, Sodium Propylparaben, DMDM Hydantoin, Dehydroacetic Acid, lodopropynyl Butylcarbamate, Salicylic Acid, Chlorphenesin, Isobutylparaben, Sodium Ethylparaben, Diazolidinyl Urea, Farnesol, Bisabolol, Sodium Phytate or Phytic Acid, Sodium Levulinate or Levulinic Acid, Chlorhexidine, Glyceryl Laurate, Anisic Acid and its salts, Chlorhexidine Digluconate, TEA-salicylate, Phenethyl Alcohol, Hexylene Glycol, Glyceryl Caprate, Sorbitan Caprylate, Tetrasodium Glutamate Diacetate, Trisodium Ethylenediamine Disuccinate, Hydroxyethoxyphenyl Butanone, Hydroxyethoxyphenyl Butanol, Itaconic Acid, Octopirox, Propanediol Caprylate, Climbazole, Undecylenoyl Glycine, Undecylenic Acid, Thymol, Glyceryl Caprylate, 4-Hydroxyacetophenone, Sodium Lactate, Trisodium Dicarboxymethyl Alaninate, 1,3-propanediol, 1,2-pentanediol, 1,2-hexanediol, 1,2-heptanediol, 1,2-octanediol, 1,2-nonanediol, 1,2-decanediol, 2,3-pentanediol, 2,3-hexanediol, 2,3-heptanediol 2,3-octanediol, 2,3-nonanediol, 2,3-decanediol and mixtures of two or more the aforesaid antimicrobial agents.

As used in the present application, the phrase “at least one antimicrobial” means that the composition can comprise one antimicrobial agent, i.e. as a single compound, or can comprise more than one antimicrobial agent, i.e. a combination with one or more further antimicrobial compounds, i.e. two, three, four or more different antimicrobial agents as specified herein. In order to enhance the antimicrobial effect and to cover a broader range of antimicrobial effect, a combination of two or more antimicrobial compounds is preferably used.

In a preferred variant, the antimicrobial agent of the composition of the present invention is selected from the group consisting of o-Cymen-5-ol, Phenoxyethanol, Disodium EDTA, Methylparaben and its salts, Caprylhydroxamic Acid, Sodium Benzoate, Benzyl Alcohol, Potassium Sorbate, Benzyl Salicylate, Methylbenzyl Alcohol, Propylparaben, Methylchloroisothiazolinone, Methylisothiazolinone, Ethylhexylglycerin, Butylparaben, Ethylparaben, Sodium Propylparaben, DMDM Hydantoin, Dehydroacetic Acid, lodopropynyl Butylcarbamate, Salicylic Acid, Chlorphenesin, Isobutylparaben, Sodium Ethylparaben, Diazolidinyl Urea, Farnesol, Bisabolol, Sodium Phytate or Phytic Acid, Sodium Levulinate or Levulinic Acid, Chlorhexidine, Glyceryl Laurate, Anisic Acid and its salts, Chlorhexidine Digluconate, TEA-Salicylate, Phenethyl Alcohol, Hexylene Glycol, Glyceryl Caprate, Sorbitan Caprylate, Tetrasodium Glutamate Diacetate, Trisodium Ethylenediamine Disuccinate, Hydroxyethoxyphenyl Butanone, Hydroxyethoxyphenyl Butanol, Itaconic Acid, Octopirox, Propanediol Caprylate, Climbazole, Undecylenic Acid, Glyceryl Caprylate, 4-Hydroxyacetophenone, Sodium Lactate, 1,3-propanediol, 1,2-pentanediol, 1,2-hexanediol, 1,2-heptanediol, 1,2-octanediol, 1,2-nonanediol, 1,2-decanediol, 2,3-pentanediol, 2,3-hexanediol, 2,3-heptanediol 2,3-octanediol, 2,3-nonanediol, 2,3-decanediol and mixtures of two or more the aforesaid antimicrobial components.

In a particularly preferred variant, the microbial active agent of the composition of the present invention is selected from the group consisting of o-Cymen-5-ol, Phenoxyethanol, Disodium EDTA, Methylparaben and its salts, Caprylhydroxamic Acid, Sodium Benzoate, Benzyl Alcohol, Potassium Sorbate, Benzyl Salicylate, Methylbenzyl Alcohol, Propylparaben, Methylchloroisothiazolinone, Methylisothiazolinone, Ethylhexylglycerin, Butylparaben, Ethylparaben, Sodium Propylparaben, DMDM Hydantoin, Hexylene Glycol, Hydroxyethoxyphenyl Butanone, Hydroxyethoxyphenyl Butanol, Itaconic Acid, Octopirox, Propanediol Caprylate, Climbazole, Undecylenic Acid, Glyceryl Caprylate, 4-Hydroxyacetophenone, 1,3-propanediol, 1,2-pentanediol, 1,2-hexanediol, 1,2-heptanediol, 1,2-octanediol, 1,2-nonanediol, 1,2-decanediol, 2,3-pentanediol, 2,3-hexanediol, 2,3-heptanediol, 2,3-octanediol, 2,3-nonanediol, 2,3-decanediol and mixtures of two or more the aforesaid antimicrobial components.

The component (b) according to the first aspect of the present invention is an alkl ketal ester compound which is represented by the general formula (I),

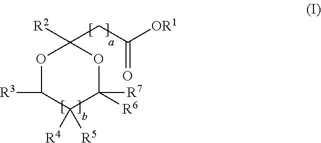

wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof.

Some compounds within the scope of the general formula (I) contain one or more chiral carbon atoms. The structure of the general formula (I) does not distinguish among those possible stereoisomers and it is intended to include all such stereoisomers.

In a preferred variant, R1 is an optionally substituted C1 to C6 alkyl, more preferred an optionally substituted C1 to C4 alkyl, most preferred an optionally substituted C1 or C2 alkyl.

In a further preferred variant of the general formula (I), R2 is hydrogen or C1 alkyl, more preferred R2 is a C1 alkyl.

In a further preferred variant of the general formula (I), R3, R4, R5, R6 and R7 are each independently hydrogen or an optionally substituted C1 to C3 alkyl, more preferred an optionally substituted C1 alkyl.

In a further preferred variant of the general formula (I), a is an integer of 1 to 6, more specifically an integer of 1 to 4, still more preferred an integer of 2 or 3.

In a still more preferred variant of the general formula (I), R1 is a C1 to C4 alkyl, R2 is methyl, each R3, R4 and R5 is independently hydrogen or a C1 to C3 alkyl, R6 is hydrogen or a C1 to C3 alkyl, R7 is hydrogen or an optionally substituted C1 to C3 alkyl, a is an integer of 2 to 3, and b is 0 or 1.

In a still more preferred variant of the general formula (I), R1 is a C1 to C4 alkyl, R2 is methyl, each R3, R4 and R5 is independently hydrogen, R5 is hydrogen, R6 is hydrogen or a C1 to C3 alkyl, R7 is hydrogen or an optionally substituted C1 to C3 alkyl, a is an integer of 2, and b is 0 or 1.

In a still more preferred variant of the general formula (I), R1 is a C1 to C4 alkyl, R2 is methyl, each R3, R4 and R5 is independently hydrogen, R5 is hydrogen, R6 is hydrogen, R7 is hydrogen, a is an integer of 2, and b is 0 or 1.

In a still more preferred variant, the alkyl ketal esters include those having the following structures (II) to (VII):

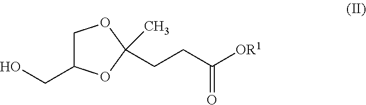

wherein R1 is methyl, ethyl n-propyl or n-butyl;

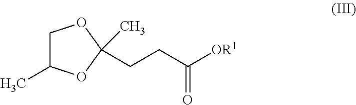

wherein R1 is methyl, ethyl n-propyl or n-butyl;

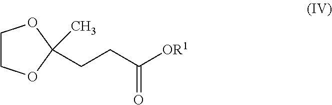

wherein R1 is methyl, ethyl n-propyl or n-butyl;

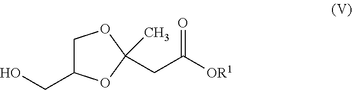

wherein R1 is methyl, ethyl n-propyl or n-butyl;

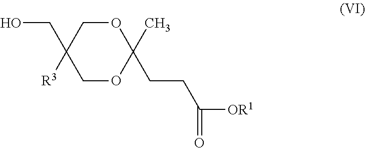

wherein R1 is methyl, ethyl, n-propyl or n-butyl; and R3 is methyl or ethyl; and

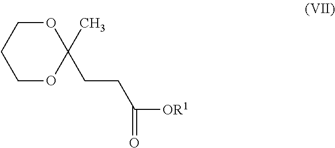

wherein R1 is methyl, ethyl, n-propyl or n-butyl.

In a most preferred variant according to the first aspect of the present invention, the alkyl ketal ester is selected from the group consisting of ethyl propylene glycol acetal levulinate

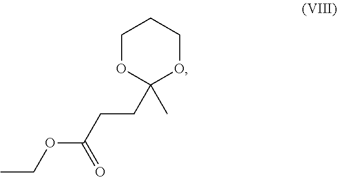

ethyl glycerine acetal levulinate

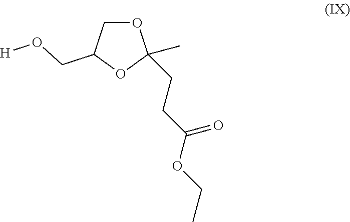

butyl-3-(2,4-dimethyl-1,3-dioxolan-2-yl-)propanoate

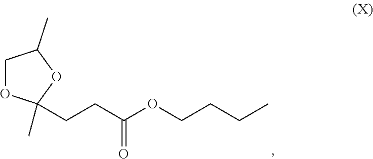 [SMILES: CCCCOC(=O)CCC1(C)OCC(C)O1]

and mixtures thereof.

The alkyl ketal ester compounds of general formula (I) are known as excellent formulation ingredients that provide benefit in a wide number. The alkyl ketal ester compounds are excellent solvents for a wide range of materials, including active agents useful in personal care formulations. Many of them are at least partially miscible with water or other organic solvents, or both, as well as a wide range of somewhat hydrophobic materials as are commonly present for example in personal care formulations. The alkyl ester compounds have low volatility. Under normal conditions of manufacture, storage and use, the alkyl ketal esters are not reactive with many of the other materials that are commonly found for example in personal car formulations. Furthermore, the alkyl ketal esters can act as an emulsifier or compatibilizer.

The alkyl ketal ester compounds as defined herein can be obtained by the acid-catalysed reaction of the corresponding ketoacid ester with a diol or alternatively by transesterification of ketal esters as it is described for example in US 2014/0147395 A1.

Surprisingly it was found that the alkyl ketal ester compounds according to the general formula (I) as defined herein, achieve synergistic antimicrobial efficacy against bacteria, yeast, and fungi/mould when combined with an antimicrobial agent as defined herein, as demonstrated in the following examples.

In a preferred advantageously variant, the composition according to the first aspect or second aspect of the present invention comprises one of the following combinations of components (a) and (b):
o-Cymen-5-ol and an alkyl ketal ester compound according to formula (I),
Isopropylparaben and an alkyl ketal ester compound according to formula (I);
Capryloyl Glycine and an alkyl ketal ester compound according to formula (I);
Phenylpropanol and an alkyl ketal ester compound according to formula (I);
Tropolone, and an alkyl ketal ester compound according to formula (I);
PCA Ethyl Cocoyl Arginate and an alkyl ketal ester compound according to formula (I);
2-Methyl-5-Cyclohexylpentanol and an alkyl ketal ester compound according to formula (I);
Phenoxyethanol and an alkyl ketal ester compound according to formula (I);
Disodium EDTA and an alkyl ketal ester compound according to formula (I);
Methylparaben or its salts and an alkyl ketal ester compound according to formula (I);
Caprylhydroxamic Acid and an alkyl ketal ester compound according to formula (I);
Sodium Benzoate and an alkyl ketal ester compound according to formula (I);
Benzyl Alcohol and an alkyl ketal ester compound according to formula (I);
Potassium Sorbate and an alkyl ketal ester compound according to formula (I);
Benzyl Salicylate and an alkyl ketal ester compound according to formula (I);
Methylbenzyl Alcohol and an alkyl ketal ester compound according to formula (I);
Propylparaben and an alkyl ketal ester compound according to formula (I);
Methylchloroisothiazolinone and an alkyl ketal ester compound according to formula (I);
Methylisothiazolinone and an alkyl ketal ester compound according to formula (I);
Ethylhexylglycerine and an alkyl ketal ester compound according to formula (I);
Butylparaben and an alkyl ketal ester compound according to formula (I);
Ethylparaben and an alkyl ketal ester compound according to formula (I);
Sodium Propylparaben and an alkyl ketal ester compound according to formula (I);
DMDM Hydantoin and an alkyl ketal ester compound according to formula (I);
Dehydroacetic Acid and an alkyl ketal ester compound according to formula (I);
lodopropynyl Butylcarbamate and an alkyl ketal ester compound according to formula (I);
Salicylic Acid and an alkyl ketal ester compound according to formula (I);
Chlorphenesin and an alkyl ketal ester compound according to formula (I);
Isobutylparaben and an alkyl ketal ester compound according to formula (I);
Sodium Ethylparaben and an alkyl ketal ester compound according to formula (I);
Diazolidinyl Urea and an alkyl ketal ester compound according to formula (I);
Farnesol and an alkyl ketal ester compound according to formula (I);
Bisabolol and an alkyl ketal ester compound according to formula (I);
Sodium Phytate or Phytic Acid and an alkyl ketal ester compound according to formula (I);
Sodium Levulinate or Levulinic Acid and an alkyl ketal ester compound according to formula (I);
Chlorhexidine and an alkyl ketal ester compound according to formula (I);
Glyceryl Laurate and an alkyl ketal ester compound according to formula (I);
Anisic Acid or its salts and an alkyl ketal ester compound according to formula (I);
Chlorhexidine Digluconate and an alkyl ketal ester compound according to formula (I);
TEA-salicylate and an alkyl ketal ester compound according to formula (I);
Phenethyl Alcohol and an alkyl ketal ester compound according to formula (I);
Hexylene Glycol and an alkyl ketal ester compound according to formula (I);
Glyceryl Caprate and an alkyl ketal ester compound according to formula (I);
Sorbitan Caprylate and an alkyl ketal ester compound according to formula (I);
Tetrasodium Glutamate Diacetate and an alkyl ketal ester compound according to formula (I);
Trisodium Ethylenediamine Disuccinate and an alkyl ketal ester compound according to formula (I);
Hydroxyethoxyphenyl Butanone and an alkyl ketal ester compound according to formula (I);
Hydroxyethoxyphenyl Butanol and an alkyl ketal ester compound according to formula (I);
Itaconic Acid and an alkyl ketal ester compound according to formula (I);
Octopirox and an alkyl ketal ester compound according to formula (I);
Propanediol Caprylate and an alkyl ketal ester compound according to formula (I);
Climbazole and an alkyl ketal ester compound according to formula (I);
Undecylenoyl Glycine and an alkyl ketal ester compound according to formula (I);
Undecylenic Acid and an alkyl ketal ester compound according to formula (I);
Thymol and an alkyl ketal ester compound according to formula (I);
Glyceryl Caprylate and an alkyl ketal ester compound according to formula (I);
4-Hydroxyacetophenone and an alkyl ketal ester compound according to formula (I);
Sodium Lactate and an alkyl ketal ester compound according to formula (I);
Trisodium Dicarboxymethyl Alaninate and an alkyl ketal ester compound according to formula (I);
1,3-propanediol and an alkyl ketal ester compound according to formula (I);
1,2-pentanediol and an alkyl ketal ester compound according to formula (I);
1,2-hexanediol and an alkyl ketal ester compound according to formula (I);
1,2-heptanediol and an alkyl ketal ester compound according to formula (I);
1,2-octanediol and an alkyl ketal ester compound according to formula (I);
1,2-nonanediol and an alkyl ketal ester compound according to formula (I);
1,2-decanediol an alkyl ketal ester compound according to formula (I);
2,3-pentanediol and an alkyl ketal ester compound according to formula (I);
2,3-hexanediol and an alkyl ketal ester compound according to formula (I);
2,3-heptanediol and an alkyl ketal ester compound according to formula (I);
2,3-octanediol and an alkyl ketal ester compound according to formula (I);
2,3-nonanediol and an alkyl ketal ester compound according to formula (I);
2,3-decanediol and an alkyl ketal ester compound according to formula (I); or
mixtures of two or more the aforesaid antimicrobial agents and and an alkyl ketal ester compound according to formula (I).

The above specified combinations of an antimicrobial agent with an alkyl ketal ester compound according to formula (I) show a synergistically antimicrobial efficacy against a broad spectrum of microorganism, i.e. against bacteria, yeast and fungi/mould compared to their respective single antimicrobial agents as it is demonstrated by the MIC (minimum inhibitory concentration) tests in the following examples.

In a more preferred advantageously variant, the composition according to the first aspect or second aspect of the present invention comprises one of the following combinations of components (a) and (b):
o-Cymen-5-ol and ethyl propylene glycol acetal levulinate;
o-Cymen-5-ol and ethyl glycerine acetal levulinate;
o-Cymen-5-ol and butyl-3-(2,4-dimethyl-1,3-dioxolan-2-yl-)propanoate;
Isopropylparaben and ethyl propylene glycol acetal levulinate;
Isopropylparaben and ethyl glycerine acetal levulinate;
lospropylparaben and butyl-3-(2,4-dimethyl-1,3-dioxolan-2-yl-)propanoate;
Capryloyl Glycine and ethyl propylene glycol acetal levulinate;
Capryloyol Glycine and ethyl glycerine acetal levulinate;
Capryloyol Glycine and butyl-3-(2,4-dimethyl-1,3-dioxolan-2-yl-)propanoate;
Phenylpropanol and ethyl propylene glycol acetal levulinate;
Phenylpropanol and ethyl glycerine acetal levulinate;
Phenylpropanol and butyl-3-(2,4-dimethyl-1,3-dioxolan-2-yl-)propanoate;
Tropolone and ethyl propylene glycol acetal levulinate;
Tropolone and ethyl glycerine acetal levulinate;
Tropolone and butyl-3-(2,4-dimethyl-1,3-dioxolan-2-yl-)propanoate;
PCA Ethyl Cocoyl Arginate and ethyl propylene glycol acetal levulinate;
PCA Ethyl Cocoyl Arginate and ethyl glycerine acetal levulinate;
PCA Ethyl Cocoyl Arginate and butyl-3-(2,4-dimethyl-1,3-dioxolan-2-yl-)propanoate;
2-Methyl-5-Cyclohexylpentanol and ethyl propylene glycol acetal levulinate:
2-Methyl-5-Cyclohexylpentanol and ethyl glycerine acetal levulinate;
2-Methyl-5-Cyclohexylpentanol and butyl-3-(2,4-dimethyl-1,3-dioxolan-2-yl-)propanoate;
Phenoxyethanol and ethyl propylene glycol acetal levulinate;
Phenoxyethanol and ethyl glycerine acetal levulinate;
Phenoxyethanol and butyl-3-(2,4-dimethyl-1,3-dioxolan-2-yl-)propanoate;
Disodium EDTA and ethyl propylene glycol acetal levulinate;
Disodium EDTA and ethyl glycerine acetal levulinate;
Disodium EDTA and butyl-3-(2,4-dimethyl-1,3-dioxolan-2-yl-)propanoate;
Methylparaben or its salts and ethyl propylene glycol acetal levulinate;
Methylparaben or its salts and ethyl glycerine acetal levulinate;
Methylparaben or its salts and butyl-3-(2,4-dimethyl-1,3-dioxolan-2-yl-)propanoate;
Caprylhydroxamic Acid and ethyl propylene glycol acetal levulinate;
Caprylhydroxamic Acid and ethyl glycerine acetal levulinate;
Caprylhydroxamic Acid and butyl-3-(2,4-dimethyl-1,3-dioxolan-2-yl-)propanoate;
Sodium Benzoate and ethyl propylene glycol acetal levulinate;
Sodium Benzoate and ethyl glycerine acetal levulinate;
Sodium Benzoate and butyl-3-(2,4-dimethyl-1,3-dioxolan-2-yl-)propanoate;
Benzyl Alcohol and ethyl propylene glycol acetal levulinate;
Benzyl Alcohol and ethyl glycerine acetal levulinate;
Benzyl Alcohol and butyl-3-(2,4-dimethyl-1,3-dioxolan-2-yl-)propanoate;
Potassium Sorbate and ethyl propylene glycol acetal levulinate;
Potassium Sorbate and ethyl glycerine acetal levulinate;
Potassium Sorbate and butyl-3-(2,4-dimethyl-1,3-dioxolan-2-yl-)propanoate;
Benzyl Salicylate and ethyl propylene glycol acetal levulinate;
Benzyl Salicylate and ethyl glycerine acetal levulinate;
Benzyl Salicylate and butyl-3-(2,4-dimethyl-1,3-dioxolan-2-yl-)propanoate;
Methylbenzyl Alcohol and ethyl propylene glycol acetal levulinate;
Methylbenzyl Alcohol and ethyl glycerine acetal levulinate;
Methylbenzyl Alcohol and butyl-3-(2,4-dimethyl-1,3-dioxolan-2-yl-)propanoate;
Propylparaben and ethyl propylene glycol acetal levulinate;
Propylparaben and ethyl glycerine acetal levulinate;
Propylparaben and butyl-3-(2,4-dimethyl-1,3-dioxolan-2-yl-)propanoate;
Methylchloroisothiazolinone and ethyl propylene glycol acetal levulinate;
Methylchloroisothiazolinone and ethyl glycerine acetal levulinate;
Methylchloroisothiazolinone and butyl-3-(2,4-dimethyl-1,3-dioxolan-2-yl-)propanoate;
Methylisothiazolinone and ethyl propylene glycol acetal levulinate;
Methylisothiazolinone and ethyl glycerine acetal levulinate;
Methylisothiazolinone and butyl-3-(2,4-dimethyl-1,3-dioxolan-2-yl-)propanoate;
Ethylhexylglycerine and ethyl propylene glycol acetal levulinate;
Ethylhexylglycerine and ethyl glycerine acetal levulinate;
Ethylhexylglycerine and butyl-3-(2,4-dimethyl-1,3-dioxolan-2-yl-)propanoate;
Butylparaben and ethyl propylene glycol acetal levulinate;
Butylparaben and ethyl glycerine acetal levulinate;
Butylparaben and butyl-3-(2,4-dimethyl-1,3-dioxolan-2-yl-)propanoate;
Ethylparaben and ethyl propylene glycol acetal levulinate;
Ethylparaben and ethyl glycerine acetal levulinate;
Ethylparaben and butyl-3-(2,4-dimethyl-1,3-dioxolan-2-yl-)propanoate;
Sodium Propylparaben and ethyl propylene glycol acetal levulinate;
Sodium Propylparaben and ethyl glycerine acetal levulinate;
Sodium Propylparaben and butyl-3-(2,4-dimethyl-1,3-dioxolan-2-yl-)propanoate;
DMDM Hydantoin and ethyl propylene glycol acetal levulinate;
DMDM Hydantoin and ethyl glycerine acetal levulinate;
DMDM Hydantoin and butyl-3-(2,4-dimethyl-1,3-dioxolan-2-yl-)propanoate;
Dehydroacetic Acid and ethyl propylene glycol acetal levulinate;
Dehydroacetic Acid and ethyl glycerine acetal levulinate;
Dehydroacetic Acid and butyl-3-(2,4-dimethyl-1,3-dioxolan-2-yl-)propanoate;
lodopropynyl Butylcarbamate and ethyl propylene glycol acetal levulinate;
lodopropynyl Butylcarbamate and ethyl glycerine acetal levulinate;
lodopropynyl Butylcarbamate and butyl-3-(2,4-dimethyl-1,3-dioxolan-2-yl-)propanoate;
Salicylic Acid and ethyl propylene glycol acetal levulinate;
Salicylic Acid and ethyl glycerine acetal levulinate;
Salicylic Acid and butyl-3-(2,4-dimethyl-1,3-dioxolan-2-yl-)propanoate;
Chlorphenesin and ethyl propylene glycol acetal levulinate;
Chlorphenesin and ethyl glycerine acetal levulinate;
Chlorphensin and butyl-3-(2,4-dimethyl-1,3-dioxolan-2-yl-)propanoate;
Isobutylparaben and ethyl propylene glycol acetal levulinate;
Isobutylparaben and ethyl glycerine acetal levulinate;
Isobutylparaben and butyl-3-(2,4-dimethyl-1,3-dioxolan-2-yl-)propanoate;
Sodium Ethylparaben and ethyl propylene glycol acetal levulinate;
Sodium Ethylparaben and ethyl glycerine acetal levulinate;
Sodium Ethylparaben and butyl-3-(2,4-dimethyl-1,3-dioxolan-2-yl-)propanoate;
Diazolidinyl Urea and ethyl propylene glycol acetal levulinate;
Diazolidinyl Urea and ethyl glycerine acetal levulinate;
Diazolidinyl Urea and butyl-3-(2,4-dimethyl-1,3-dioxolan-2-yl-)propanoate;
Farnesol and ethyl propylene glycol acetal levulinate;
Farnesol and ethyl glycerine acetal levulinate;
Farnesol and butyl-3-(2,4-dimethyl-1,3-dioxolan-2-yl-)propanoate;
Bisabolol and ethyl propylene glycol acetal levulinate;
Bisabolol and ethyl glycerine acetal levulinate;
Bisabolol and butyl-3-(2,4-dimethyl-1,3-dioxolan-2-yl-)propanoate;
Sodium Phytate or Phytic Acid and ethyl propylene glycol acetal levulinate;
Sodium Phytate or Phytic Acid and ethyl glycerine acetal levulinate;
Sodium Phytate or Phytic Acid and butyl-3-(2,4-dimethyl-1,3-dioxolan-2-yl-)propanoate;
Sodium Levulinate or Levulinic Acid and ethyl propylene glycol acetal levulinate;
Sodium Levulinate or Levulinic Acid and ethyl glycerine acetal levulinate;
Sodium Levulinate or Levulinic Acid and butyl-3-(2,4-dimethyl-1,3-dioxolan-2-yl-)propanoate;
Chlorhexidine and ethyl propylene glycol acetal levulinate;
Chlorhexidine and ethyl glycerine acetal levulinate;
Chlorhexidine and butyl-3-(2,4-dimethyl-1,3-dioxolan-2-yl-)propanoate;
Glyceryl Laurate and ethyl propylene glycol acetal levulinate;
Glyceryl Laurate and ethyl glycerine acetal levulinate;
Glyceryl Laurate and butyl-3-(2,4-dimethyl-1,3-dioxolan-2-yl-)propanoate;
Anisic Acid or its salts and ethyl propylene glycol acetal levulinate;
Anisic Acid or its salts and ethyl glycerine acetal levulinate;
Anisic Acid or its salts and butyl-3-(2,4-dimethyl-1,3-dioxolan-2-yl-)propanoate;
Chlorhexidine Digluconate and ethyl propylene glycol acetal levulinate;
Chlorhexidine Digluconate and ethyl glycerine acetal levulinate;
Chlorhexidine Digluconate and butyl-3-(2,4-dimethyl-1,3-dioxolan-2-yl-)propanoate;
TEA-salicylate and ethyl propylene glycol acetal levulinate;
TEA-salicylate and ethyl glycerine acetal levulinate;
TEA-salicylate and butyl-3-(2,4-dimethyl-1,3-dioxolan-2-yl-)propanoate;
Phenethyl Alcohol and ethyl propylene glycol acetal levulinate;
Phenethyl Alcohol and ethyl glycerine acetal levulinate;
Phenethyl Alcohol and butyl-3-(2,4-dimethyl-1,3-dioxolan-2-yl-)propanoate;
Hexylene Glycol and ethyl propylene glycol acetal levulinate;
Hexylene Glycol and ethyl glycerine acetal levulinate;
Hexylane Glycol and butyl-3-(2,4-dimethyl-1,3-dioxolan-2-yl-)propanoate;
Glyceryl Caprate and ethyl propylene glycol acetal levulinate;
Glyceryl Caprate and ethyl glycerine acetal levulinate;
Glyceryl Caprate and butyl-3-(2,4-dimethyl-1,3-dioxolan-2-yl-)propanoate;
Sorbitan Caprylate and ethyl propylene glycol acetal levulinate>;
Sorbitan Caprylate and ethyl glycerine acetal levulinate;
Sorbitan Caprylate and butyl-3-(2,4-dimethyl-1,3-dioxolan-2-yl-)propanoate;
Tetrasodium Glutamate Diacetate and ethyl propylene glycol acetal levulinate;
Tetrasodium Glutamate Diacetate and ethyl glycerine acetal levulinate;
Tetrasodium Glutamate Diacetate and butyl-3-(2,4-dimethyl-1,3-dioxolan-2-yl-)propanoate;
Trisodium Ethylenediamine Disuccinate and ethyl propylene glycol acetal levulinate;
Trisodium Ethylenediamine Disuccinate and ethyl glycerine acetal levulinate;
Trisodium Ethylenediamine Disuccinate and butyl-3-(2,4-dimethyl-1,3-dioxolan-2-yl-)propanoate;
Hydroxyethoxyphenyl Butanone and ethyl propylene glycol acetal levulinate;
Hydroxyethoxyphenyl Butanone and ethyl glycerine acetal levulinate;
Hydroxyethoxyphenyl Butanone and butyl-3-(2,4-dimethyl-1,3-dioxolan-2-yl-)propanoate;
Hydroxyethoxyphenyl Butanol and ethyl propylene glycol acetal levulinate;
Hydroxyethoxyphenyl Butanol and ethyl glycerine acetal levulinate;
Hydroxyethoxyphenyl Butanol and butyl-3-(2,4-dimethyl-1,3-dioxolan-2-yl-)propanoate;
Itaconic Acid and ethyl propylene glycol acetal levulinate;
Itaconic Acid and ethyl glycerine acetal levulinate;
Itaconic Acid and butyl-3-(2,4-dimethyl-1,3-dioxolan-2-yl-)propanoate;
Octopirox and ethyl propylene glycol acetal levulinate;
Octopirox and ethyl glycerine acetal levulinate;
Octopirox and butyl-3-(2,4-dimethyl-1,3-dioxolan-2-yl-)propanoate;
Propanediol Caprylate and ethyl propylene glycol acetal levulinate;
Propanediol Caprylate and ethyl glycerine acetal levulinate;
Propanediol Caprylate and butyl-3-(2,4-dimethyl-1,3-dioxolan-2-yl-)propanoate;
Climbazole and ethyl propylene glycol acetal levulinate;
Climbazole and ethyl glycerine acetal levulinate;
Climbazole and butyl-3-(2,4-dimethyl-1,3-dioxolan-2-yl-)propanoate;
Undecylenoyl Glycine and ethyl propylene glycol acetal levulinate;
Undecylenoyl Glycine and ethyl glycerine acetal levulinate;
Undecylenoyl Glycine and butyl-3-(2,4-dimethyl-1,3-dioxolan-2-yl-)propanoate;
Undecylenic Acid and ethyl propylene glycol acetal levulinate;
Undecylenic Acid and ethyl glycerine acetal levulinate;
Undecylenic Acid and butyl-3-(2,4-dimethyl-1,3-dioxolan-2-yl-)propanoate;
Thymol and ethyl propylene glycol acetal levulinate;
Thymol and ethyl glycerine acetal levulinate;
Thymol and butyl-3-(2,4-dimethyl-1,3-dioxolan-2-yl-)propanoate;
Glyceryl Caprylate and ethyl propylene glycol acetal levulinate;
Glyceryl Caprylate and ethyl glycerine acetal levulinate;
Glyceryl Caprylate and butyl-3-(2,4-dimethyl-1,3-dioxolan-2-yl-)propanoate;
4-Hydroxyacetophenone and ethyl propylene glycol acetal levulinate;
4-Hydroxyacetophenone and ethyl glycerine acetal levulinate;
4-Hydroxyacetophenone and butyl-3-(2,4-dimethyl-1,3-dioxolan-2-yl-)propanoate;
Sodium Lactate and ethyl propylene glycol acetal levulinate;
Sodium Lactate and ethyl glycerine acetal levulinate;
Sodium Lactate and butyl-3-(2,4-dimethyl-1,3-dioxolan-2-yl-)propanoate;
Trisodium Dicarboxymethyl Alaninate and ethyl propylene glycol acetal levulinate;
Trisodium Dicarboxymethyl Alaninate and ethyl glycerine acetal levulinate;
Trisodium Dicarboxymethyl Alaninate and butyl-3-(2,4-dimethyl-1,3-dioxolan-2-yl-)propanoate;
1,3-propanediol and ethyl propylene glycol acetal levulinate;
1,3-propanediol and ethyl glycerine acetal levulinate;
1,3-propanediol and butyl-3-(2,4-dimethyl-1,3-dioxolan-2-yl-)propanoate;
1,2-pentanediol and ethyl propylene glycol acetal levulinate:
1,2-pentanediol and ethyl glycerine acetal levulinate;
1,2-pentanediol and butyl-3-(2,4-dimethyl-1,3-dioxolan-2-yl-)propanoate;
1,2-hexanediol and ethyl propylene glycol acetal levulinate;
1,2-hexanediol and ethyl glycerine acetal levulinate;
1,2-hexanediol and butyl-3-(2,4-dimethyl-1,3-dioxolan-2-yl-)propanoate;
1,2-heptanediol and ethyl propylene glycol acetal levulinate;
1,2-heptanediol and ethyl glycerine acetal levulinate;
1,2-heptanediol and butyl-3-(2,4-dimethyl-1,3-dioxolan-2-yl-)propanoate;
1,2-octanediol and ethyl propylene glycol acetal levulinate;
1,2-octanediol and ethyl glycerine acetal levulinate;
1,2-octanediol and butyl-3-(2,4-dimethyl-1,3-dioxolan-2-yl-)propanoate;
1,2-nonanediol and ethyl propylene glycol acetal levulinate;
1,2-nonanediol and ethyl glycerine acetal levulinate;
1,2-nonanediol and butyl-3-(2,4-dimethyl-1,3-dioxolan-2-yl-)propanoate;
1,2-decanediol and ethyl propylene glycol acetal levulinate;
1,2-decanediol and ethyl glycerine acetal levulinate;
1,2-decanediol and butyl-3-(2,4-dimethyl-1,3-dioxolan-2-yl-)propanoate;
2,3-pentanediol and ethyl propylene glycol acetal levulinate;
2,3-pentanediol and ethyl glycerine acetal levulinate;
2,3-pentanediol and butyl-3-(2,4-dimethyl-1,3-dioxolan-2-yl-)propanoate;
2,3-hexanediol and ethyl propylene glycol acetal levulinate;
2,3-hexanediol and ethyl glycerine acetal levulinate;
2,3-hexanediol and butyl-3-(2,4-dimethyl-1,3-dioxolan-2-yl-)propanoate;
2,3-heptanediol and ethyl propylene glycol acetal levulinate;
2,3-heptanediol and ethyl glycerine acetal levulinate;
2,3-heptanediol and butyl-3-(2,4-dimethyl-1,3-dioxolan-2-yl-)propanoate;
2,3-octanediol and ethyl propylene glycol acetal levulinate;
2,3-octanediol and ethyl glycerine acetal levulinate;
2,3-octanediol and butyl-3-(2,4-dimethyl-1,3-dioxolan-2-yl-)propanoate;
2,3-nonanediol and ethyl propylene glycol acetal levulinate;
2,3-nonanediol and ethyl glycerine acetal levulinate;
2,3-nonanediol and butyl-3-(2,4-dimethyl-1,3-dioxolan-2-yl-)propanoate;
2,3-decanediol and ethyl propylene glycol acetal levulinate;
2,3-decanediol and ethyl glycerine acetal levulinate;
2,3-decanediol and butyl-3-(2,4-dimethyl-1,3-dioxolan-2-yl-)propanoate;
mixtures of two or more of the aforesaid antimicrobial agents and ethyl propylene glycol acetal levulinate;
mixtures of two or more of the aforesaid antimicrobial agents and ethyl glycerine acetal levulinate; or
mixtures of two or more of the aforesaid antimicrobial agents and butyl-3-(2,4-dimethyl-1,3-dioxolan-2-yl-)propanoate.

Still more preferred combinations of components (a) and (b) in the composition according to the first aspect of the present invention are:
o-Cymen-5-ol and ethyl propylene glycol acetal levulinate;
o-Cymen-5-ol and ethyl glycerine acetal levulinate;
o-Cymen-5-ol and butyl-3-(2,4-dimethyl-1,3-dioxolan-2-yl-)propanoate;
Phenoxyethanol and ethyl propylene glycol acetal levulinate;
Phenoxyethanol and ethyl glycerine acetal levulinate;
Phenoxyethanol and butyl-3-(2,4-dimethyl-1,3-dioxolan-2-yl-)propanoate;
Disodium EDTA and ethyl propylene glycol acetal levulinate;
Disodium EDTA and ethyl glycerine acetal levulinate;
Disodium EDTA and butyl-3-(2,4-dimethyl-1,3-dioxolan-2-yl-)propanoate;
Methylparaben or its salts and ethyl propylene glycol acetal levulinate;
Methylparaben and ethyl glycerine acetal levulinate;
Methylparaben and butyl-3-(2,4-dimethyl-1,3-dioxolan-2-yl-)propanoate;
Caprylhydroxamic Acid and ethyl propylene glycol acetal levulinate;
Caprylhydroxamic Acid and ethyl glycerine acetal levulinate;
Caprylhydroxamic Acid and butyl-3-(2,4-dimethyl-1,3-dioxolan-2-yl-)propanoate;
Sodium Benzoate and ethyl propylene glycol acetal levulinate;
Sodium Benzoate and ethyl glycerine acetal levulinate;
Sodium Benzoate and butyl-3-(2,4-dimethyl-1,3-dioxolan-2-yl-)propanoate;
Benzyl Alcohol and ethyl propylene glycol acetal levulinate;
Benzyl Alcohol and ethyl glycerine acetal levulinate;
Benzyl Alcohol and butyl-3-(2,4-dimethyl-1,3-dioxolan-2-yl-)propanoate;
Potassium Sorbate and ethyl propylene glycol acetal levulinate;
Potassium Sorbate and ethyl glycerine acetal levulinate;
Potassium Sorbate and butyl-3-(2,4-dimethyl-1,3-dioxolan-2-yl-)propanoate;
Benzyl Salicylate and ethyl propylene glycol acetal levulinate;
Benzyl Salicylate and ethyl glycerine acetal levulinate;
Benzyl Salicylate and butyl-3-(2,4-dimethyl-1,3-dioxolan-2-yl-)propanoate;
Methylbenzyl Alcohol and ethyl propylene glycol acetal levulinate;
Methylbenzyl Alcohol and ethyl glycerine acetal levulinate;
Methylbenzyl Alcohol and butyl-3-(2,4-dimethyl-1,3-dioxolan-2-yl-)propanoate;
Propylparaben and ethyl propylene glycol acetal levulinate;
Propylparaben and ethyl glycerine acetal levulinate;
Propylparaben and butyl-3-(2,4-dimethyl-1,3-dioxolan-2-yl-)propanoate;
Methylchloroisothiazolinone and ethyl propylene glycol acetal levulinate;
Methylchloroisothiazolinone and ethyl glycerine acetal levulinate;
Methylchloroisothiazolinone and butyl-3-(2,4-dimethyl-1,3-dioxolan-2-yl-)propanoate;
Methylisothiazolinone and ethyl propylene glycol acetal levulinate;
Methylisothiazolinone and ethyl glycerine acetal levulinate;
Methylisothiazolinone and butyl-3-(2,4-dimethyl-1,3-dioxolan-2-yl-)propanoate;
Ethylhexylglycerine and ethyl propylene glycol acetal levulinate;
Ethylhexylglycerine and ethyl glycerine acetal levulinate;
Ethylhexylglycerine and butyl-3-(2,4-dimethyl-1,3-dioxolan-2-yl-)propanoate;
Butylparaben and ethyl propylene glycol acetal levulinate;
Butylparaben and ethyl glycerine acetal levulinate;
Butylparaben and butyl-3-(2,4-dimethyl-1,3-dioxolan-2-yl-)propanoate;
Ethylparaben and ethyl propylene glycol acetal levulinate;
Ethylparaben and ethyl glycerine acetal levulinate;
Ethylparaben and butyl-3-(2,4-dimethyl-1,3-dioxolan-2-yl-)propanoate;
Sodium Propylparaben and ethyl propylene glycol acetal levulinate;
Sodium Propylparaben and ethyl glycerine acetal levulinate;
Sodium Propylparaben and butyl-3-(2,4-dimethyl-1,3-dioxolan-2-yl-)propanoate;
DMDM Hydantoin and ethyl propylene glycol acetal levulinate;
DMDM Hydantoin and ethyl glycerine acetal levulinate;
DMDM Hydantoin and butyl-3-(2,4-dimethyl-1,3-dioxolan-2-yl-)propanoate;
Hexylene Glycol and ethyl propylene glycol acetal levulinate;
Hexylene Glycol and ethyl glycerine acetal levulinate;
Hexylene Glycol and butyl-3-(2,4-dimethyl-1,3-dioxolan-2-yl-)propanoate;
Hydroxyethoxyphenyl Butanone and ethyl propylene glycol acetal levulinate;
Hydroxyethoxyphenyl Butanone and ethyl glycerine acetal levulinate;
Hydroxyethoxyphenyl Butanone and butyl-3-(2,4-dimethyl-1,3-dioxolan-2-yl-)propanoate;
Hyxdroxyethoxyphenyl Butanol and ethyl propylene glycol acetal levulinate;
Hydroxyethoxyphenyl Butanol and ethyl glycerine acetal levulinate;
Hydroxyethoxyphenyl and butyl-3-(2,4-dimethyl-1,3-dioxolan-2-yl-)propanoate;
Itaconic Acid and ethyl propylene glycol acetal levulinate;
Itaconic Acid and ethyl glycerine acetal levulinate;
Itaconic Acid and butyl-3-(2,4-dimethyl-1,3-dioxolan-2-yl-)propanoate;
Octopirox and ethyl propylene glycol acetal levulinate;
Octopirox and ethyl glycerine acetal levulinate;
Octopirox and butyl-3-(2,4-dimethyl-1,3-dioxolan-2-yl-)propanoate;
Propanediol Caprylate and ethyl propylene glycol acetal levulinate;
Propanediol Caprylate and ethyl glycerine acetal levulinate;
Propanediol Caprylate and butyl-3-(2,4-dimethyl-1,3-dioxolan-2-yl-)propanoate;
Climbazole and ethyl propylene glycol acetal levulinate;
Climbazole and ethyl glycerine acetal levulinate;
Climbazole and butyl-3-(2,4-dimethyl-1,3-dioxolan-2-yl-)propanoate;
Undecylenic Acid and ethyl propylene glycol acetal levulinate;
Undecylenic Acid and ethyl glycerine acetal levulinate;
Undecylenic Acid and butyl-3-(2,4-dimethyl-1,3-dioxolan-2-yl-)propanoate;
Glyceryl Caprylate and ethyl propylene glycol acetal levulinate;
Glyceryl Caprylate and ethyl glycerine acetal levulinate;
Glyceryl Caprylate and butyl-3-(2,4-dimethyl-1,3-dioxolan-2-yl-)propanoate;
4-Hydroxyacetophenone and ethyl propylene glycol acetal levulinate;
4-Hydroxyacetophenone and ethyl glycerine acetal levulinate;
4-Hydroxyacetophenone and butyl-3-(2,4-dimethyl-1,3-dioxolan-2-yl-)propanoate;
1,3-propanediol and ethyl propylene glycol acetal levulinate;
1,3-propanediol and ethyl glycerine acetal levulinate;
1,3-propanediol and butyl-3-(2,4-dimethyl-1,3-dioxolan-2-yl-)propanoate;
1,2-pentanediol and ethyl propylene glycol acetal levulinate;
1,2-pentanediol and ethyl glycerine acetal levulinate;
1,2-pentanediol and butyl-3-(2,4-dimethyl-1,3-dioxolan-2-yl-)propanoate;
1,2-hexanediol and ethyl propylene glycol acetal levulinate;
1,2-hexanediol and ethyl glycerine acetal levulinate;
1,2-hexanediol and butyl-3-(2,4-dimethyl-1,3-dioxolan-2-yl-)propanoate;
1,2-heptanediol and ethyl propylene glycol acetal levulinate;
1,2-heptanediol and ethyl glycerine acetal levulinate;
1,2-heptanediol and butyl-3-(2,4-dimethyl-1,3-dioxolan-2-yl-)propanoate;
1,2-octanediol and ethyl propylene glycol acetal levulinate;
1,2-octanediol and ethyl glycerine acetal levulinate;
1,2-octanediol and butyl-3-(2,4-dimethyl-1,3-dioxolan-2-yl-)propanoate;
1,2-nonanediol and ethyl propylene glycol acetal levulinate;
1,2-nonanediol and ethyl glycerine acetal levulinate;
1,2-nonanediol and butyl-3-(2,4-dimethyl-1,3-dioxolan-2-yl-)propanoate;
1,2-decanediol and ethyl propylene glycol acetal levulinate;
1,2-decanediol and ethyl glycerine acetal levulinate;
1,2-decanediol and butyl-3-(2,4-dimethyl-1,3-dioxolan-2-yl-)propanoate;
2,3-pentanediol and ethyl propylene glycol acetal levulinate;
2,3-pentanediol and ethyl glycerine acetal levulinate;
2,3-pentanediol and butyl-3-(2,4-dimethyl-1,3-dioxolan-2-yl-)propanoate;
2,3-hexanediol and ethyl propylene glycol acetal levulinate;
2,3-hexanediol and ethyl glycerine acetal levulinate;
2,3-hexanediol and butyl-3-(2,4-dimethyl-1,3-dioxolan-2-yl-)propanoate;
2,3-octanediol and ethyl propylene glycol acetal levulinate;
2,3-octanediol and ethyl glycerine acetal levulinate;
2,3-octanediol and butyl-3-(2,4-dimethyl-1,3-dioxolan-2-yl-)propanoate;
2,3-nonanediol and ethyl propylene glycol acetal levulinate;
2,3-nonanediol and ethyl glycerine acetal levulinate;
2,3-nonanediol and butyl-3-(2,4-dimethyl-1,3-dioxolan-2-yl-)propanoate;
2,3-decanediol and ethyl propylene glycol acetal levulinate;
2,3-decanediol and ethyl glycerine acetal levulinate;
2,3-decanediol and butyl-3-(2,4-dimethyl-1,3-dioxolan-2-yl-)propanoate;
mixtures of two or more the aforesaid antimicrobial agents and ethyl propylene glycol acetal levulinate;
mixtures of two or more of the aforesaid antimicrobial agents and ethyl glycerine acetal levulinate; or
mxitures of two or more of the aforesaid antimicrobial agents and butyl-3-(2,4-dimethyl-1,3-dioxolan-2-yl-)propanoate.

Most preferred combinations of components (a) and (b) in the composition according to the first aspect of the present invention are:
o-Cymen-5-ol and ethyl propylene glycol acetal levulinate;
o-Cymen-5-ol and ethyl glycerine acetal levulinate;
o-Cymen-5-ol and butyl-3-(2,4-dimethyl-1,3-dioxolan-2-yl-)propanoate;
Ethylhexylglycerine and ethyl propylene glycol acetal levulinate;
Ethylhexylglycerine and ethyl glycerine acetal levulinate;
Ethylhexylglycerine and butyl-3-(2,4-dimethyl-1,3-dioxolan-2-yl-)propanoate;
Glyceryl Caprylate and ethyl propylene glycol acetal levulinate;
Glyceryl Caprylate and ethyl glycerine acetal levulinate;
Glyceryl Caprylate and butyl-3-(2,4-dimethyl-1,3-dioxolan-2-yl-)propanoate;
4-Hydroxyacetophenone and ethyl propylene glycol acetal levulinate;
4-Hydroxyacetophenone and ethyl glycerine acetal levulinate;
4-Hydroxyacetophenone and butyl-3-(2,4-dimethyl-1,3-dioxolan-2-yl-)propanoate;
1,3-propanediol and ethyl propylene glycol acetal levulinate;
1,3-propanediol and ethyl glycerine acetal levulinate;
1,3-propanediol and butyl-3-(2,4-dimethyl-1,3-dioxolan-2-yl-)propanoate;
1,2-pentanediol and ethyl propylene glycol acetal levulinate;
1,2-pentanediol and ethyl glycerine acetal levulinate;
1,2-pentanediol and butyl-3-(2,4-dimethyl-1,3-dioxolan-2-yl-)propanoate;
1,2-hexanediol and ethyl propylene glycol acetal levulinate;
1,2-hexanediol and ethyl glycerine acetal levulinate;
1,2-hexanediol and butyl-3-(2,4-dimethyl-1,3-dioxolan-2-yl-)propanoate;
1,2-heptanediol and ethyl propylene glycol acetal levulinate;
1,2-heptanediol and ethyl glycerine acetal levulinate;
1,2-heptanediol and butyl-3-(2,4-dimethyl-1,3-dioxolan-2-yl-)propanoate;
1,2-octanediol and ethyl propylene glycol acetal levulinate;
1,2-octanediol and ethyl glycerine acetal levulinate;
1,2-octanediol and butyl-3-(2,4-dimethyl-1,3-dioxolan-2-yl-)propanoate;
1,2-nonanediol and ethyl propylene glycol acetal levulinate;
1,2-nonanediol and ethyl glycerine acetal levulinate;
1,2-nonanediol and butyl-3-(2,4-dimethyl-1,3-dioxolan-2-yl-)propanoate;
1,2-decanediol and ethyl propylene glycol acetal levulinate;
1,2-decanediol and ethyl glycerine acetal levulinate;
1,2-decanediol and butyl-3-(2,4-dimethyl-1,3-dioxolan-2-yl-)propanoate;
2,3-pentanediol and ethyl propylene glycol acetal levulinate;
2,3-pentanediol and ethyl glycerine acetal levulinate;
2,3-pentanediol and butyl-3-(2,4-dimethyl-1,3-dioxolan-2-yl-)propanoate;
2,3-hexanediol and ethyl propylene glycol acetal levulinate;
2,3-hexanediol and ethyl glycerine acetal levulinate;
2,3-hexanediol and butyl-3-(2,4-dimethyl-1,3-dioxolan-2-yl-)propanoate;
2,3-octanediol and ethyl propylene glycol acetal levulinate;
2,3-octanediol and ethyl glycerine acetal levulinate;
2,3-octanediol and butyl-3-(2,4-dimethyl-1,3-dioxolan-2-yl-)propanoate;
2,3-nonanediol and ethyl propylene glycol acetal levulinate;
2,3-nonanediol and ethyl glycerine acetal levulinate;
2,3-nonanediol and butyl-3-(2,4-dimethyl-1,3-dioxolan-2-yl-)propanoate;
2,3-decanediol and ethyl propylene glycol acetal levulinate;
2,3-decanediol and ethyl glycerine acetal levulinate;
2,3-decanediol and butyl-3-(2,4-dimethyl-1,3-dioxolan-2-yl-)propanoate;
mixtures of two or more of the aforesaid antimicrobial agents and ethyl propylene glycol acetal levulinate;
mixtures of two or more of the aforesaid antimicrobial agents and ethyl glycerine acetal levulinate; or
mixture of two or more of the aforesaid antimicrobial agents and butyl-3-(2,4-dimethyl-1,3-dioxolan-2-yl-)propanoate.

In the above defined antimicrobial substance/alkyl ketal ester compound combinations, the alkyl ketal ester compound can be used either as single compound in combination with an antimicrobial agent or can be used as mixture of two or more alkyl ketal ester compounds in combination with an antimicrobial agent. Particular beneficial are combinations of an antimicrobial agent with a mixture of ethyl propylene glycol acetal levulinate and ethyl glycerine acetal levulinate or with a mixture of ethyl propylene glycol acetal levulinate and butyl-3-(2,4-dimethyl-1,3-dioxolan-2-yl-)propanoate or with a mixture of ethyl glycerine acetal levulinate and/or and butyl-3-(2,4-dimethyl-1,3-dioxolan-2-yl-)propanoate. Such combinations exhibit a pronounced synergistically antimicrobial efficacy against a broad spectrum of microorganism, i.e. against bacteria, yeast and fungi/mould in comparison to their single antimicrobial agents.

The above specified combinations of an antimicrobial agent with ethyl propylene glycol acetal levulinate and/or ethyl glycerine acetal levulinate and/or and butyl-3-(2,4-dimethyl-1,3-dioxolan-2-yl-)propanoate are characterized by a synergistically antimicrobial efficacy against a broad spectrum of microorganism, i.e. against bacteria, yeast and fungi/mould compared to their respective single antimicrobial agents as it is demonstrated by the MIC (minimum inhibitory concentration) tests in the following examples.

Said synergistic antimicrobial effect is particularly observed for the combination of o-Cymen-5-ol and ethyl propylene glycol acetal levulinate and/or ethyl glycerine acetal levulinate and/or butyl-3-(2,4-dimethyl-1,3-dioxolan-2-yl-)propanoate.

Also the combination of Ethylhexylglycerine and ethyl propylene glycol acetal levulinate and/or ethyl glycerine acetal levulinate and/or butyl-3-(2,4-dimethyl-1,3-dioxolan-2-yl-)propanoate is particularly advantageous.

Also ethyl propylene glycol acetal levulinate and/or ethyl glycerine acetal levulinate and or butyl-3-(2,4-dimethyl-1,3-dioxolan-2-yl-)propanoate in combination with the antimicrobial Glyceryl Caprylate synergistically reduces the microbial load when used in combination with different antimicrobials.

A synergistic antimicrobial effect is also true for 4-Hydroxyacetophenone in combination with ethyl propylene glycol acetal levulinate and/or ethyl glycerine acetal levulinate and/or butyl-3-(2,4-dimethyl-1,3-dioxolan-2-yl-)propanoate.

A synergistic antimicrobial effect could also be demonstrated for 1,3-propanediol when used in combination with ethyl propylene glycol acetal levulinate and/or ethyl glycerine acetal levulinate and/or butyl-3-(2,4-dimethyl-1,3-dioxolan-2-yl-)propanoate.

The afore-mentioned synergistically intensified antimicrobial effect is particularly pronounced for a combination with a 1,2-alkanediol such as 1,2-pentanediol, 1,2-hexanediol, 1,2-heptanediol, 1,2-octanediol, 1,2-nonanediol and 1,2-decanediol and ethyl propylene glycol acetal levulinate and/or ethyl glycerine acetal levulinate and/or butyl-3-(2,4-dimethyl-1,3-dioxolan-2-yl-)propanoate compared to the corresponding individual 1,2-alkanediol substances.

A synergistic antimicrobial effect could also be observed for the 2,3-alkanediol analogues such as 2,3-pentanediol, 2,3-hexanediol, 2,3-heptanediol, 2,3-octanediol, 2,3-nonanediol and 2,3-decanediol when combined with ethyl propylene glycol acetal levulinate and/or ethyl glycerine acetal levulinate and/or butyl-3-(2,4-dimethyl-1,3-dioxolan-2-yl-)propanoate.

The above-described combinations including an antimicrobial agent and ethyl propylene glycol acetal levulinate and/or ethyl glycerine acetal levulinate and/or butyl-3-(2,4-dimethyl-1,3-dioxolan-2-yl-)propanoate display a remarkably synergistic antimicrobial activity and are clearly superior to the individually corresponding antimicrobial agents and having the same concentration.

Hence, with the use of such antimicrobial combinations according to the present invention, the microbial growth in food, or cosmetic or pharmaceutical compositions or home care products can be considerably inhibited, and, thus, microbial load in such formulations can be considerably reduced. Consequently, the storage stability of such formulations can be considerably improved, and, thus, the shelf live can be prolonged. Moreover, the risk of spoilage during individual customer use is significantly reduced.

The synergistic antimicrobial effect of the above-described combinations of an antimicrobial agent and ethyl propylene glycol acetal levulinate and/or ethyl glycerine acetal levulinate and/or butyl-3-(2,4-dimethyl-1,3-dioxolan-2-yl-)propanoate allows to reduce the amount of antimicrobial agent in the final preparation without losing the antimicrobial effect.

The above-defined specific combinations can be combined with one or more further components (c) such as active substances for food, cosmetic or pharmaceutical compositions or home care product and/or additives as described later on.

In order to further enhance antimicrobial efficacy, the composition as defined herein, is advantageously combined with at least one further antimicrobial agent which is different from the component (a) of the composition according to the present invention.

The combination with a further antimicrobial agent provides reliable protection against microbial degradation and deterioration of the food or cosmetic or pharmaceutical preparation, in particular during storage. Additionally, the further different antimicrobial agent provides reliable protection against other microorganisms as described above, for example Corynebacterium, Anaerococcus, Finegoldia, Moraxella, Porphyromonas, Fusobacterium, Malassezia, Peptoniphilus, Streptococcus, Lactobacillus, Gardnerella, Fannyhessea, Epidermophyton, Trichophyton, Cutibacterium. Hence, the combination with a further different antimicrobial agent allows antimicrobial protection against different groups of microorganisms, and, thus, a broader spectrum of microorganism.

Furthermore, with the additional different antimicrobial agent the composition according to the present invention can also be provided with a different antimicrobial target, preferably antimicrobials for skin protection.

The further different antimicrobial agent in the context of the present invention is preferably selected from the group consisting of 2-benzylheptanol, alkyl (C 12-22) trimethyl ammonium bromide and chloride, ascorbic acid and salts thereof, benzalkonium bromide, benzalkonium chloride, benzalkonium saccharinate, benzethonium chloride, BenzoicAcid, camphor, cetylpyridinium chloride, chlorhexidine diacetate, chlorhexidine dihydrochloride, chlorocresol, chloroxylenol, Cyclohexylglycerin, Dimethyl phenylbutanol, Dimethyl phenylpropanol, ethanol, ethyl lauroyl arginate HCl, Ethyl Lauroyl Arginate Laurate, eucalyptol, gluconic acid and salts thereof, glycerin, hexamidine, hexamidine diisethionate, Hexylglycerin, lodopropynyl Butylcarbamate, jasmol, lauryl alcohol, Levulinic Acid, mannitol, menthol, methyl salicylate, Octenidine HCl, polyarginine, Polyglyceryl-10 Laurate, polyglyceryl-2 caprate, Polyglyceryl-3 caprylate, polylysine, Salvia Officinalis (Sage) Oil, silver chloride, silver citrate, sodium caproyl lactylate, Sodium Caproyl/Lauroyl Lactylate, sodium lauroyl lactylate, Sorbic Acid, sorbitol, Tetraselmis extract, triclocarban, triclosan, Triethyl citrate, Xylityl Sesquicaprylate, zinc citrate, zinc pyrithione, Zinc ricinoleate, and mixtures of two or more of the aforesaid antimicrobial agents.

In a more preferred variant, the further different antimicrobial agent is selected from the group consisting of 2-benzylheptanol, Benzoic Acid, Dimethyl phenylbutanol, Dimethyl phenylpropanol, ethyl lauroyl arginate HCl, Ethyl Lauroyl Arginate Laurate, gluconic acid and salts thereof, Glyceryl laurate, jasmol, lauryl alcohol, Levulinic Acid, Mannitol, Octenidine HCl, Polyglyceryl-10 Laurate, polyglyceryl-2 caprate, Polyglyceryl-3 caprylate, Salvia Officinalis (Sage) Oil, sodium caproyl lactylate, Sodium Caproyl/Lauroyl Lactylate, sodium lauroyl lactylate, Sorbic Acid, sorbitol, Tetraselmis extract, Triclosan, Triethyl citrate, Xylityl Sesquicaprylate, Zinc ricinoleate, and mixtures of two or more of the aforesaid antimicrobial agents.

Within the context of the present invention, it is also possible and in some cases advantageous to combine the composition according to the first aspect of the present invention with other customary active substances, adjuvants or additives.

Optionally, other conventional cosmetically and/or pharmaceutically active substances, adjuvants or additives, as further described below, may be added as component (c), i.e. in order to obtain a ready-for-use preparation or formulation such as food, cosmetic or pharmaceutical preparation or preparation for animal care.

The composition according to the present invention can advantageously be combined with other cosmetically or pharmaceutically active agents and/or adjuvants and/or additives or auxiliaries, such as are customarily used in such preparations or formulations, such as for example abrasives, anti-acne agents, agents against ageing of the skin, anti-cellulitis agents, anti-dandruff agents, anti-inflammatory agents, irritation-preventing agents, irritation-inhibiting agents, antioxidants, astringents, odour absorbers, perspiration-inhibiting agents, antiseptic agents, anti-statics, binders, buffers, carrier materials, chelating agents, cell stimulants, cleansing agents, depilatory agents, surface-active substances, deodorizing agents, antiperspirants, softeners, emulsifiers, enzymes, enzyme inhibitors, essential oils, fibres, film-forming agents, fixatives, foam-forming agents, foam stabilizers, substances for preventing foaming, foam boosters, gelling agents, gel-forming agents, hair care agents, hair-setting agents, hair-straightening agents, moisture-donating agents, moisturizing substances, moisture-retaining substances, bleaching agents, strengthening agents, stain-removing agents, optically brightening agents, impregnating agents, dirt-repellent agents, dyes, friction-reducing agents, lubricants, moisturizing creams, ointments, opacifying agents, plasticizing agents, covering agents, polish, preservatives, gloss agents, green and synthetic polymers, powders, proteins, re-oiling agents, abrading agents, silicones, skin-soothing agents, skin-cleansing agents, skin care agents, skin-healing agents, skin-lightening agents, skin-protecting agents, skin-softening agents, hair promotion agents, cooling agents, skin-cooling agents, warming agents, skin-warming agents, stabilizers, surfactants, UV-absorbing agents, UV filters, primary sun protection factors, secondary sun protection factors, detergents, fabric conditioning agents, suspending agents, skin-tanning agents, actives modulating skin or hair pigmentation, matrix-metalloproteinase inhibitors, skin moisturizing agents, glycosaminoglycan stimulators, TRPV1 antagonists, desquamating agents, anti-cellulite agents or fat enhancing agents, hair growth activators or inhibitors, thickeners, rheology additives, vitamins, oils, waxes, pearlizing waxes, fats, phospholipids, saturated fatty acids, mono- or polyunsaturated fatty acids, a-hydroxy acids, polyhydroxy fatty acids, liquefiers, dyestuffs, colour-protecting agents, pigments, anti-corrosives, fragrances or perfume oils, aromas, flavouring substances, odoriferous substances, polyols, electrolytes, organic solvents, and mixtures of two or more of the aforementioned substances, as further described below.

Of the above cosmetically or pharmaceutically active agents and/or adjuvants and/or additives or auxiliary agents against ageing of the skin, antioxidants, chelating agents, emulsifiers, surfactants, green and synthetic polymers, skin-cooling agents, rheology additives, oils, fragrances or perfume oils, and polyols are particularly preferred in the preparation of cosmetic and pharmaceutical composition.

The cosmetically or pharmaceutically active agents and/or adjuvants and/or additives can in some instances provide one or more than one benefit or operate via more than one mode of action.

Since dermatological conditions or diseases are often associated with dry skin, scratched skin, skin lesions or even inflammation, the composition according to the present invention advantageously contains preferably anti-inflammatories, antibacterial or antimycotic substances, substances having a reddening-alleviating or itch-alleviating action, lenitive substances, moisturisers and/or cooling agents, osmolytes, keratolytic substances, nurturing substances, anti-inflammatory, antibacterial or antimycotic substances, substances having a reddening-alleviating or itch-alleviating action, lenitive substances, anti-dandruff substances, or other active compounds such as solvents, fragrances antioxidants, preservatives, (metal) chelating agents, penetration enhancers, or mixtures of two or more of afore specified agents.

In addition to the above-described substances, further ingredients commonly used in the cosmetic or pharmaceutical industry, which are suitable or customary in the compositions of the present invention, can be used.

The at least one alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, is present in the composition according to the first aspect of the present invention or in the ready to use product, i.e., in the final food or cosmetic or pharmaceutical preparation or home care product, in an amount of 0.001 to 15.0% by weight, based on the total weight of the composition or final food, cosmetic or pharmaceutical preparation or home care product.

In a preferred variant, the composition or the final preparation comprises the alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, in an amount of 0.01 to 10.0% by weight, based on the total weight of the composition or final food, cosmetic or pharmaceutical preparation or home care product.

In a particular preferred variant, alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, is advantageously used in the composition or final preparation in an amount of at 0.1 to 5.0% by weight, based on the total weight of the composition or final food, cosmetic or pharmaceutical preparation or home care product.

For an alkyl ketal ester compound mixture, such as ethyl propylene glycol acetal levulinate and ethyl glycerine acetal levulinate, the above amounts refer to the total content both compounds in the mixture, i.e. the amount is the sum of the content of the ethyl propylene glycol acetal levulinate and ethyl glycerine acetal levulinate in the mixture.

The antimicrobial component is present in the composition according to the present invention or the final cosmetic or pharmaceutical preparation in an amount of 0.01 to 25.0% by weight, based on the total weight of the composition or final food, cosmetic or pharmaceutical preparation or home care product.

In a preferred variant, the composition or the final cosmetic or pharmaceutical preparation or home care product comprises the antimicrobial component in an amount of 0.02 to 15.0% by weight, based on the total weight of the composition or final food, cosmetic or pharmaceutical preparation or home care product.

In a particular preferred variant, the antimicrobial component is advantageously used in the composition or in the final cosmetic or pharmaceutical preparation in an amount of at 0.05 to 6.0% by weight, based on the total weight of the composition or final food, cosmetic or pharmaceutical preparation.

As is demonstrated in the following examples the alkyl ketal ester compounds considerably boost the antimicrobial efficacy of an antimicrobial component against bacteria, yeast and fungi/mould in a food, cosmetic or pharmaceutical composition.

Surprisingly, the combination of an antimicrobial component as defined above with an alkyl ketal ester compound according to the present invention result in a synergistic microbial effect.

A synergistic effect is an effect achieved when two different chemical substances or biological structures interact resulting in an overall effect that is greater than the sum of individual effects of any of them.

Such a synergistic effect is particularly achieved for ethyl propylene glycol acetal levulinate or ethyl glycerine acetal levulinate or butyl-3-(2,4-dimethyl-1,3-dioxolan-2-yl-)propanoate or a combination of two or three of said levulinate compounds. The use of said compounds, either singular or in combination considerably boosts the antimicrobial effect of an antimicrobial component against bacteria, yeast and fungi/mould in a food, cosmetic or pharmaceutical preparation.

The synergistic antimicrobial effect has the advantage that the antimicrobial efficiency of the antimicrobial component is broadened, either by achieving a higher performance of an antimicrobial component with the same amounts, or, vice versa, by achieving the same performance with lower amounts of an antimicrobial component, so that the overall content of the antimicrobial component in the composition can be reduced.

In a second aspect, the present invention relates to an antimicrobial compound represented by the general formula (I)

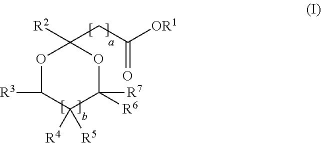

wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof.

Some alkyl ketal ester compounds within the scope of the general formula (I) contain one or more chiral carbon atoms. The structure of the general formula (I) does not distinguish among those possible stereoisomers and it is intended to include all such stereoisomers.

In a preferred variant of the general formula (I), R1 is an optionally substituted C1 to C6 alkyl, more preferred an optionally substituted C1 to C4 alkyl, most preferred an optionally substituted C1 or C2 alkyl.

In a further preferred variant of the general formula (I), R2 is hydrogen or C1 alkyl, more preferred R2 is a C1 alkyl.

In a further preferred variant of the general formula (I), R3, R4, R5, R6 and R7 are each independently hydrogen or an optionally substituted C1 to C3 alkyl, more preferred an optional substituted C1 alkyl.

In a further preferred variant of the general formula (I), a is an integer of 1 to 6, more specifically an integer of 1 to 4, still more preferred an integer of 2 or 3.

In a still more preferred variant of the general formula (I), R1 is a C1 to C4 alkyl, R2 is methyl, each R3, R4 and R5 is independently hydrogen or a C1 to C3 alkyl, R6 is hydrogen or a C1 to C3 alkyl, R7 is hydrogen or an optionally substituted C1 to C3 alkyl, a is an integer of 2 to 3, and b is 0 or 1.

In a still more preferred variant of the general formula (I), R1 is a C1 to C4 alkyl, R2 is methyl, each R3, R4 and R5 is independently hydrogen, R5 is hydrogen, R6 is hydrogen or a C1 to C3 alkyl, R7 is hydrogen or an optionally substituted C1 to C3 alkyl, a is an integer of 2, and b is 0 or 1.

In a still more preferred variant of the general formula (I), R1 is a C1 to C4 alkyl, R2 is methyl, each R3, R4 and R5 is independently hydrogen, R5 is hydrogen, R6 is hydrogen, R7 is hydrogen, a is an integer of 2, and b is 0 or 1.

In a still more preferred variant, the alkyl ketal esters include those having the following structures (II) to (VII):

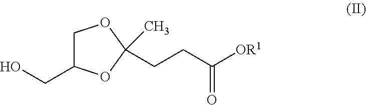

wherein R1 is methyl, ethyl n-propyl or n-butyl;

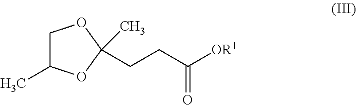

wherein R1 is methyl, ethyl n-propyl or n-butyl;

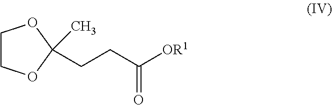

wherein R1 is methyl, ethyl n-propyl or n-butyl;

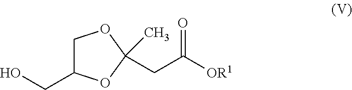

wherein R1 is methyl, ethyl n-propyl or n-butyl;

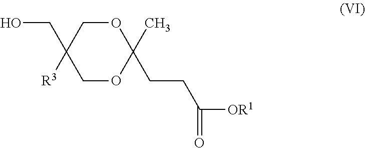

wherein R1 is methyl, ethyl, n-propyl or n-butyl; and R3 is methyl or ethyl; and

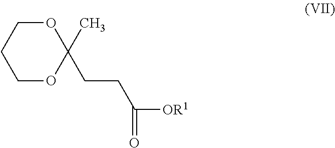

wherein R1 is methyl, ethyl, n-propyl or n-butyl.

In a most preferred variant according to the second aspect of the present invention, the alkyl ketal ester is selected from the group consisting of ethyl propylene glycol acetal levulinate

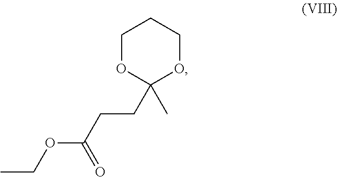

ethyl glycerine acetal levulinate

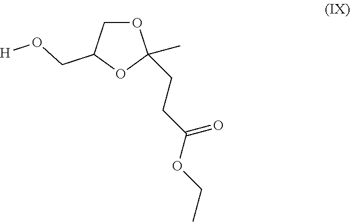

butyl-3-(2,4-dimethyl-1,3-dioxolan-2-yl-)propanoate

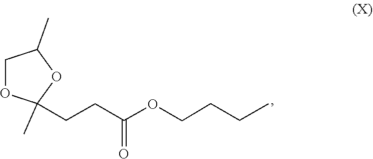 [SMILES: CCCCOC(=O)CCC1(C)OCC(C)O1]

and mixtures thereof.

The alkyl ketal ester compounds of general formula (I) are known as excellent formulation ingredients that provide benefit in a wide number. The alkyl ketal ester compounds are excellent solvents for a wide range of materials, including active agents useful in personal care formulations. Many of them are at least partially miscible with water or other organic solvents, or both, as well as a wide range of somewhat hydrophobic materials as are commonly present for example in personal care formulations. The alkyl ester compounds have low volatility. Under normal conditions of manufacture, storage and use, the alkyl ketal esters are not reactive with many of the other materials that are commonly found for example in personal car formulations. Furthermore, the alkyl ketal esters can act as an emulsifier or compatibilizer.

The alkyl ketal ester compounds as defined herein can be obtained by the acid-catalysed reaction of the corresponding ketoacid ester with a diol or alternatively by transesterification of ketal esters as it is described for example in US 2014/0147395 A1.

Surprisingly it was found that the alkyl ketal ester compounds according to the general formula (I) as defined herein, have a pronounced antimicrobial efficacy.

The antimicrobial compounds according to the general formula (I) of the present invention act primarily against microorganisms, in particular bacteria, yeast and/or fungi. Specified microorganisms are aerobic mesophilic bacteria or yeast or fungi undesirable in a cosmetic product that may be harmful for human health or as an indication of hygienic failure in the manufacturing process. Microorganisms considered as specified microorganisms according to the present invention are of the genus Pseudomonas (bacterium), Staphylococcus (bacterium), Escherichia (bacterium), Candida (yeast) and Aspergillus (fungi), and combinations thereof.

More preferably, the microorganisms are selected from the group consisting of Pseudomonas aeruginosa, Staphylococcus aureus, Escherichia coli, Candida albicans and Aspergillus brasiliensis, and combinations thereof.

In a most preferred variant according to the second aspect of the present invention, among the antimicrobial compounds of the general formula (I) as defined herein, the compounds ethyl propylene glycol acetal levulinate, ethyl glycerine acetal levulinate, butyl-3-(2,4-dimethyl-1,3-dioxolan-2-yl-)propanoate or mixtures of two or three of said compounds are particularly beneficial, since they exhibit a distinctive antimicrobial efficacy.

The antimicrobial efficacy of the above specified compounds or mixtures thereof is particularly pronounced against the microorganisms Pseudomonas aeruginosa, Staphylococcus aureus, Escherichia coli, Candida albicans and Aspergillus brasiliensis.

The antimicrobial alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, is present in the ready to use product, i.e., in the final food or cosmetic or pharmaceutical preparation or home care product, in an amount of 0.001 to 15.0% by weight, based on the total weight of the final food, cosmetic or pharmaceutical preparation or home care product.

In a preferred variant, the final preparation comprises the alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, in an amount of 0.01 to 10.0% by weight, based on the total weight of the final food, cosmetic or pharmaceutical preparation or home care product.

In a particular preferred variant, the alkyl ketal ester compound, especially the ethyl propylene glycol acetal levulinate and/or ethyl glycerine acetal levulinate and/or butyl-3-(2,4-dimethyl-1,3-dioxolan-2-yl-)propanoate, is advantageously used in the final preparation in an amount of at 0.1 to 5.0% by weight, based on the total weight of the final food, cosmetic or pharmaceutical preparation.

For an alkyl ketal ester compound mixture consisting of ethyl propylene glycol acetal levulinate and/or ethyl glycerine acetal levulinate and/or butyl-3-(2,4-dimethyl-1,3-dioxolan-2-yl-)propanoate, the above amounts refer to the total content of the alkyl ketal ester compounds in the mixture, i.e. the amount is the sum of the content of the ethyl propylene glycol acetal levulinate and/or ethyl glycerine acetal levulinate and/or butyl-3-(2,4-dimethyl-1,3-dioxolan-2-yl-)propanoate in the mixture.

Due to the described advantageously properties, the antimicrobial composition according to the first aspect of the present invention and the antimicrobial alkyl ketal ester compounds according to the second aspect of the present invention can be used for the preparation of food, cosmetic or pharmaceutical preparations or home care products which can be microbially stabilized thereby. The microbial stabilization allows the food, cosmetic or pharmaceutical preparations or homecare products to be stored without microbial degradation and deterioration, thus improving the shelf life of food, cosmetic or pharmaceutical preparations or home care products.

Hence, the present invention relates in a further aspect of the present invention to food, cosmetic or pharmaceutical preparations or home care products comprising the antimicrobial composition according to the present invention or the antimicrobial compound as defined herein.

The cosmetic or pharmaceutical, in particular dermatological, composition according to the present invention is intended for topical applications. The term “topical” is understood to mean external applications on a mammal's skin, which are in particular for the treatment, protection, care and cleansing of the skin, scalp, eyelashes, eyebrows, nails, mucous membranes and hair. The mammal is preferably a human.

For topical application, the cosmetic or pharmaceutical preparation is either a rinse off or leave on preparation.

The cosmetic or pharmaceutical, in particular dermatological, preparation according to the present invention can be present in different forms of, e.g. in the form of a dispersion, in the form of a liquid surfactant formulation, in the form of a solid surfactant formulation, or in the form of an aqueous, aqueous/alcoholic, in particular aqueous/ethanolic, or an aqueous/glycolic solution.

In a preferred variant, the cosmetic or pharmaceutical preparation according to the present invention is a dispersion. The term “dispersion” in the context of the present invention means, that the cosmetic or pharmaceutical preparation is a disperse two-phase system consisting of colloidal particles (disperse phase) and a medium in which they are suspended (disperse medium). Both phases are not miscible with each other, only with an emulsifier. Such dispersions, for example emulsions, comprise the oil component preferably in an amount of 1% by weight, more preferably in an amount of 3% by weight.

If the cosmetic or pharmaceutical preparation according to the present invention is a dispersion, preferably an emulsion, the oil component is present in the cosmetic or pharmaceutical preparation in an amount of 0.01% to 50.0 by weight, based on the total weight of the composition. In a preferred variant, the cosmetic or pharmaceutical preparation comprises the oil component in an amount of 1.0 to 40.0% by weight, based on the total weight of the composition. In a particular preferred variant, the oil component is advantageously used in the cosmetic or pharmaceutical preparation in an amount of at 3.0 to 30% by weight, based on the total weight of the composition.

Preferably, the cosmetic or pharmaceutical preparation according to the first aspect or second aspect of the present invention takes various forms such as an emulsion, in particular a O/W emulsion, a W/O emulsion, a multiple emulsion, a hydro dispersion gel, a balm, a multiple emulsion of the water-in-oil type (W/0/WO) or of the oil-in-water type (O/W/O), PIT emulsion, Pickering emulsion, a micro-emulsion, a liquid, a lotion, a suspension, a milk, an ointment, a paste, a gel, a cream based, an oil based or a liposome-based formulation.

In a further alternative, the cosmetic or pharmaceutical preparation according to the present invention is a liquid surfactant formulation.

Such liquid surfactant formulations include for example shampoo, shower gel, micellar water, liquid soap, cleansing preparations.

If the cosmetic or pharmaceutical preparation according to the present invention is a liquid surfactant composition, the surfactant component is present in the cosmetic or pharmaceutical preparation in an amount of 1 to 40% by weight, preferably in an amount of 3 to 30% by weight, more preferably in an amount of 5 to 25% by weight, based on the total weight of the composition.

In a further alternative, the cosmetic or pharmaceutical preparation according to the present invention is a solid surfactant formulation.

Such solid surfactant formulations include for example solid shampoos, solid body wash, bar soaps.

Alternatively, and particularly preferred, the cosmetic or pharmaceutical preparation as disclosed herein is an aqueous or aqueous/alcoholic or aqueous/glycolic based solution. The aqueous/alcoholic or aqueous/glycolic based solution comprises an aliphatic alcohol or a glycol in an amount of 0.1 to ≤50% by weight, based on the total weight of the solution. The aliphatic alcohol is preferably selected from the group consisting of ethanol, isopropanol, n-propanol. The glycol is preferably selected from the group consisting of glycerine, propylene glycol, butylene glycol or dipropylene glycol. Preferably, the overall water content in the final composition of such compositions can be ≥60%, more preferably ≥70%, even more preferably ≥80%, even more preferably ≥90%, and in special cases preferably ≥90%. New applications such as those including water wipes have high water content. In a particular variant, the inventive compositions can be used for such wet wipe applications. They may then most preferably contain ≥95% water, or even ≥98% water.

Such aqueous or aqueous/alcoholic or aqueous/glycolic based solutions include for example deo/antiperspirant roll-ons, after shaves, cleansing preparations, anti-acne preparations, or wet wipe solutions.

In one preferred variant, the cosmetic or pharmaceutical preparation according to the present invention is in the form of an emulsion as defined herein, advantageously in the form of an oil-in-water (O/W) emulsion comprising an oily phase dispersed in an aqueous phase in the presence of an O/W emulsifier.

In a most preferred variant, the cosmetic or pharmaceutical preparation according to the present invention is in the form of an aqueous or aqueous/alcoholic, preferably aqueous/ethanolic, or aqueous/glycolic based solution. Typically, this could be glycerine in water compositions.

The above cosmetic or pharmaceutical preparations of formulations are prepared according to usual and known methods.

In a preferred variant, the cosmetic preparation according to the present invention is a preparation for cosmetic and/or non-therapeutic use for personal care, skin protection, skin care, scalp protection, scalp care, hair care, nail care, in particular for the prevention and/or treatment of skin conditions, intolerant or sensitive skin, skin irritation, skin reddening, rosacea, wheals, pruritus (itching), skin aging, wrinkle formation, loss of skin volume, loss of skin elasticity, pigment spots, pigment abnormalities, skin dryness, flaking, greasiness, hypopigmentation and/or hyperpigmentation of the skin; or for animal care.

Examples of personal care are preferably anti-ageing preparations, skin care emulsions, body oils, body lotions, cleansing lotions, face or body balms, after shave balms, after sun balms, deo emulsions, cationic emulsions, body gels, treatment creams, skin protection ointments, moisturizing gels, face and/or body moisturizers, light protective preparations (sunscreens), micellar water, hair spray, colour protection hair care products, skin lightening product, anti-dark spot preparations, etc.

The home care products according to the present invention are predominantly detergent formulations, usually liquids, powders, sprays, granules or tablets, used to remove dirt, including dust, stains, bad smells and clutter on surfaces or other types of housecleaning or laundry detergent that is added for cleaning laundry or liquid soap. Typical homecare products include all-purpose cleaners, dishwashing detergents, hard floor and surface cleaners, glass cleaners, carpet cleaners, oven cleaners, laundry detergents, fabric softeners, laundry scent, scent lotions, car shampoo, rim block gel, car shampoo or furniture polish, all afore-mentioned goods also in encapsulated form or air fresheners.

Due to their outstanding antimicrobial efficacy the composition according to the first aspect of the present invention and the antimicrobial compounds according to the second aspect of the present invention are suitable for the preservation of food, cosmetic or pharmaceutical preparations or home care products.

Thus, in a further aspect the present invention relates to the use of the composition according to the first aspect of the present invention and the use of the antimicrobial compound according to the second aspect of the present invention for suppressing or inhibiting microorganisms' growth in food, a cosmetic or pharmaceutical preparations. Here the present compositions and novel antimicrobial compounds are valuable in ensuring good preservation of said products. The suppression or inhibition of the growth of microorganisms is a reduction of the microorganisms' growth rate and/or stagnation or reduction of the number of living microorganisms. By suppressing or inhibiting the microorganisms' growth, the degradation and deterioration of the cosmetic or pharmaceutical preparation, especially during storage, which sometimes goes along with impairment of the sensory quality of the products, can be prevented or at least minimized.

A use is further preferred, wherein the microorganisms are selected from the group consisting of the genus Staphylococcus, Candida, Aspergillus, Pseudomonas and Escherichia, and combinations thereof, in particular selected from the group consisting of Staphylococcus aureus, Candida albicans, Aspergillus brasiliensis, Pseudomonas aeruginosa, Escherichia coli, and combinations thereof, more particular Candida albicans und Aspergillus brasiliensis. The antimicrobial composition according to the first aspect of the present invention and the antimicrobial compounds according to the second aspect of the present invention showed excellent efficacy against these microorganisms.

Surprisingly, ethyl propylene glycol acetal levulinate or ethyl glycerine acetal levulinate or butyl-3-(2,4-dimethyl-1,3-dioxolan-2-yl-)propanoate in combination with an antimicrobial agent as defined herein has been found to synergistically enhance the antimicrobial effect thereof.

Thus, the present invention relates in a further aspect to the use of alkyl ketal ester compounds according to the present invention, preferably ethyl propylene glycol acetal levulinate and/or ethyl glycerine acetal levulinate and/or butyl-3-(2,4-dimethyl-1,3-dioxolan-2-yl-)propanoate, for boosting the efficacy of an antimicrobial component, preferably in food, cosmetic or pharmaceutical preparation.

Due to the above-described advantageous properties resulting from the use of an alkyl ketal ester compound, preferably ethyl propylene glycol acetal levulinate and/or ethyl glycerine acetal levulinate and/or butyl-3-(2,4-dimethyl-1,3-dioxolan-2-yl-)propanoate, the amount of an antimicrobial agent in food, cosmetic or pharmaceutical preparation can be reduced.

Finally, the present invention also relates to a method for suppressing or inhibiting of microorganisms' growth in food, a cosmetic or a pharmaceutical preparation or home care products as defined herein. In the method according to the invention a food, a cosmetic or a pharmaceutical preparation or home care product is provided. Next, an effective amount of the antimicrobial composition according to the first aspect of the present invention or an antimicrobial compound according to the second aspect of the present invention is incorporated into the food, cosmetic or pharmaceutical preparation or home care product thereby achieving preservation of said products.

The present invention shall now be described in detail with reference to the following examples, which are merely illustrative of the present invention, such that the content of the present invention is not limited by or to the following examples.

### EXAMPLES

### Example 1

The Minimum Inhibitory Concentration (MIC) test is a test on growth inhibition. The estimation of MICs is executed in 96 well plates. Through the comparison of bacterial growth with positive and negative controls via optical density (OD), different concentrations of given test substances are evaluated.

Bacteria were cultivated under adjusted conditions based on information of the German Collection of Microorganisms and Cell Cultures (DSMZ) and stored in 10% or 50% glycerol prior to use. Afterwards, the following method was applied: Growth medium (according to microorganism) was added to each well of the microplate. Then, the test-substances, solved in DMSO, were added in different concentrations, positive controls (water controls only with medium), solvent controls (DMSO controls only with medium), and negative controls (benchmarks according to organism). Finally, the microorganisms were added in a concentration of 1 to 6×10⁶ CFU/ml (CFU=colony forming units). The incubation of the microplates was carried out at appropriate conditions.

According to the resulting growth, substance concentrations are labelled either as inhibiting or not and MIC is defined as the lowest concentration where a complete growth inhibition is visible. Experiments at concentration limits (highest concentration labelled as growth and lowest concentration labelled as inhibiting) are performed at least twice.

The synergistic activity of NxtSolv 320 (Ethyl propylene glycol acetal levulinate) and Nxt Solv 420 (Ethyl glycerine acetal levulinate) in combination with different antimicrobial compounds was determined by measuring the Minimum Inhibitory Concentrations (MIC) according to the method as described above. Tested concentrations were in general: 10,000 ppm steps between 100,000 and 50,000 ppm, 5,000 ppm steps between 50,000 ppm and 10,000 ppm, 2,500 ppm steps below 10,000 ppm and 2,500 ppm, and 1,000 ppm. In special occasions, intermediate dilution steps were performed to further improve the MIC resolution. Pure Ethyl propylene glycol acetal levulinate samples showed no effect up to 100,000 ppm against Pseudomonas aeruginosa and MIC was set to 100,000 to determine a possible synergistic effect.

To verify that the tested combinations act synergistically against microorganisms, corresponding experiments were conducted with Staphylococcus aureus, Candida albicans, Aspergillus brasiliensis, Pseudomonas aeruginosa and Escherichia coli. The synergistic activities of Ethyl propylene glycol acetal levulinate and Ethyl glycerine acetal levulinate and different antimicrobial compounds in a mixture of 50% and 50% were determined by measuring the MIC of the mixture.

In order to calculate the synergy index with MIC values, the Kull equation was used as follows:

$$SI = ( {MIC}_{mixture} \times {P}_{A} ) / {MIC}_{A} + ( {MIC}_{micture} \times {P}_{B} ) / {MIC}_{B}$$

wherein
SI is the Synergy Index according to Kull
MIC_{A} is the MIC value for Substance A
MIC_{B} is the MIC value for Substance B
MICₘᵢₓₜᵤᵣₑ is the MIC value for the mixture of substances A and B
P_{A} is the proportion of the substance A in the mixture
P_{B} is the proportion of the substance B in the mixture

### Example 1.1: MIC Values and Synergy Index of Ethyl Propylene Glycol Acetal Levulinate in Combination with 4-Hydroxyacetophenone Against Staphylococcus aureus, Candida Albicans, Aspergillus Brasiliensis, Pseudomonas Aeruginosa and Escherichia coli

TABLE 1

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl propylene | 60,000 | 20,000 | 10,000 | 100,000 | 15,000 |
| glycol acetal | | | | | |
| levulinate | | | | | |
| 4-Hydroxy- | 5,000 | 6,000 | 2,500 | 4,000 | 2,500 |
| acetophenone | | | | | |
| Ethyl propylene | 7,500 | 5,000 | 500 | 5,000 | 5,000 |
| glycol acetal | | | | | |
| levulinate plus | | | | | |
| 4-Hydroxy- | | | | | |
| acetophenone | | | | | |
| (mixture 50:50) | | | | | |
| | Synergy Index [SI = (MICmix × PA)/MICA + | | | | |
| | (MICmix × PB)/MICB] | | | | |
| | 0.81 | 0.54 | 0.13 | 0.65 | 1.17 |

For the tested antimicrobial component, synergistic effects regarding the antimicrobial efficacy were found with SI values below 1. For a mixture of 50%:50% of Ethyl propylene glycol acetal levulinate and 4-Hydroxyacetophenone the respective MIC values were determined, resulting in Synergy Indices of 0.81 against Staphylococcus aureus, 0.54 against Candida albicans, 0.13 against Aspergillus brasiliensis and 0.65 against Pseudomonas aeruginosa. The best synergistic effect could be achieved for the combination against Candida albicans and Aspergillus brasiliensis. This means that with the addition Ethyl propylene glycol acetal levulinate, the concentration of the antimicrobial component can be reduced while the same antimicrobial effect can be obtained. Hence, the use of Ethyl propylene glycol acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl propylene glycol acetal levulinate.

### Example 1.2: MIC Values and Synergy Index of Ethyl Propylene Glycol Acetal Levulinate in Combination with Hydrolite 5 Green Against Staphylococcus aureus, Candida Albicans, Aspergillus Brasiliensis, Pseudomonas Aeruginosa and Escherichia coli

TABLE 2

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl propylene | 60,000 | 20,000 | 10,000 | 100,000 | 15,000 |
| glycol | | | | | |
| acetal levulinate | | | | | |
| 1,2-Pentanediol | 35,000 | 12,500 | 17,500 | 30,000 | 15,000 |
| Ethyl propylene | 25,000 | 25,000 | 2,500 | 25,000 | 20,000 |
| glycol | | | | | |
| acetal levulinate plus | | | | | |
| 1,2-Pentanediol | | | | | |
| (mixture 50:50) | | | | | |
| | Synergy Index [SI = (MICmix × PA)/MICA + | | | | |
| | (MICmix × PB)/MICB] | | | | |
| | 0.57 | 1.63 | 0.20 | 0.54 | 1.33 |

For the tested antimicrobial component, synergistic effects regarding the antimicrobial efficacy were found with SI values below 1. For a mixture of 50%:50% of Ethyl propylene glycol acetal levulinate and Hydrolite 5 green (1,2-pentanediol) the respective MIC values were determined, resulting in Synergy Indices of 0.20 against Aspergillus brasiliensis and 0.54 against Pseudomonas aeruginosa. The best synergistic effect could be achieved for the combination against Aspergillus brasiliensis. This means that with the addition Ethyl propylene glycol acetal levulinate, the concentration of the antimicrobial component can be reduced while the same antimicrobial effect can be obtained. Hence, the use of Ethyl propylene glycol acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl propylene glycol acetal levulinate.

### Example 1.3: MIC Values and Synergy Index of Ethyl Propylene Glycol Acetal Levulinate in Combination with Ethylhexylglycerine Against Staphylococcus aureus, Candida Albicans, Aspergillus Brasiliensis, Pseudomonas Aeruginosa and Escherichia coli

TABLE 3

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl propylene | 60,000 | 20,000 | 10,000 | 100,000 | 15,000 |
| glycol acetal | | | | | |
| levulinate | | | | | |
| Ethylhexylglycerin | 1,000 | 1,000 | 1,000 | 50,000 | 2,500 |
| Ethyl propylene | 2,500 | 2,500 | 2,500 | 30,000 | 2,500 |
| glycol acetal | | | | | |
| levulinate plus | | | | | |
| Ethylhexylglycerine | | | | | |
| (mixture 50:50) | | | | | |
| | Synergy Index [SI = (MICmix × PA)/MICA + | | | | |
| | (MICmix × PB)/MICB] | | | | |
| | 1.27 | 1.31 | 1.38 | 0.45 | 0.58 |

For the tested antimicrobial component, synergistic effects regarding the antimicrobial efficacy were found with SI values below 1. For a mixture of 50%: 50% Ethyl propylene glycol acetal levulinate and Ethylhexylglycerine the respective MIC values were determined, resulting in a Synergy Index of 0.45 against Pseudomonas aeruginosa and 0.55 against Escherichia coli. The best synergistic effect could be achieved for the combination against Pseudomonas aeruginosa. This means that with the addition of Ethyl propylene glycol acetal levulinate, the concentration of the antimicrobial component can be reduced while the same antimicrobial effect can be obtained. Hence, the use of Ethyl propylene glycol acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl propylene glycol acetal levulinate.

### Example 1.4: MIC Values and Synergy Index of Ethyl Glycerine Acetal Levulinate in Combination with 4-Hydroxyacetophenone Against Staphylococcus aureus, Candida Albicans, Aspergillus Brasiliensis, Pseudomonas Aeruginosa and Escherichia coli

TABLE 4

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl glycerine acetal | 17,500 | 25,000 | 15,000 | 35,000 | 25,000 |
| levulinate | | | | | |
| 4-Hydroxy- | 5,000 | 6,000 | 2,500 | 4,000 | 2,500 |
| acetophenone | | | | | |
| Ethyl glycerine acetal | 7,500 | 5,000 | 2,500 | 5,000 | 5,000 |
| levulinate plus | | | | | |
| 4-Hydroxy- | | | | | |
| acetophenone | | | | | |
| (mixture 50:50) | | | | | |
| | Synergy Index [SI = (MICmix × PA)/MICA + | | | | |
| | (MICmix × PB)/MICB] | | | | |
| | 0.96 | 0.52 | 0.58 | 0.70 | 1.10 |

For the tested antimicrobial component, synergistic effects regarding the antimicrobial efficacy were found with SI values below 1. For a mixture of 50%:50% of Ethyl glycerine acetal levulinate and 4-Hydroxyacetophenone the respective MIC values were determined, resulting in Synergy Indices of 0.96 against Staphylococcus aureus, 0.52 against Candida albicans, 0.58 against Aspergillus brasiliensis and 0.70 against Pseudomonas aeruginosa. The best synergistic effect could be achieved for the combination against the fungi Candida albicans and Aspergillus brasiliensis. This means that with the addition Ethyl glycerine acetal levulinate, the concentration of the antimicrobial component can be reduced while the same antimicrobial effect can be obtained. Hence, the use Ethyl glycerine acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl glycerine acetal levulinate.

### Example 1.5: MIC Values and Synergy Index of Ethyl Glycerine Acetal Levulinate in Combination with Hydrolite 5 Green Against Staphylococcus aureus, Candida Albicans, Aspergillus Brasiliensis, Pseudomonas Aeruginosa and Escherichia coli

TABLE 5

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl glycerine acetal | 17,500 | 25,000 | 15,000 | 35,000 | 25,000 |
| levulinate | | | | | |
| 1,2-Pentanediol | 35,000 | 12,500 | 17,500 | 30,000 | 15,000 |
| Ethyl glycerine acetal | 35,000 | 25,000 | 15,000 | 20,000 | 17,500 |
| levulinate plus | | | | | |
| 1,2-Pentanediol | | | | | |
| (mixture 50:50) | | | | | |
| | Synergy Index [SI = (MICmix × PA)/ | | | | |
| | MICA + (MICmix × PB)/MICB] | | | | |
| | 1.50 | 1.50 | 0.93 | 0.62 | 0.93 |

For the tested antimicrobial component, synergistic effects regarding the antimicrobial efficacy were found with SI values below 1. For a mixture of 50%:50% of Ethyl glycerine acetal levulinate and 1,2-pentanediol the respective MIC values were determined, resulting in Synergy Indices of 0.93 against Aspergillus brasiliensis, 0.62 against Pseudomonas aeruginosa, and 0.93 against Escherichia coli. The best synergistic effect could be achieved for the combination against Pseudomonas aeruginosa. This means that with the addition of Ethyl glycerine acetal levulinate, the concentration of the antimicrobial component can be reduced while the same antimicrobial effect can be obtained. Hence, the use of Ethyl glycerine acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl glycerine acetal levulinate.

### Example 1.6: MIC Values and Synergy Index of Ethyl Glycerine Acetal Levulinate in Combination with Ethylhexylglycerine Against Staphylococcus aureus, Candida Albicans, Aspergillus Brasiliensis, Pseudomonas Aeruginosa and Escherichia coli

TABLE 6

| | MIC in ppm | | | | |
|---|---|---|---|---|---|
| | Staphylococcus | Candida | Aspergillus | Pseudomonas | Escherichia |
| Test substances | aureus | albicans | brasiliensis | aeruginosa | coli |
| Ethyl glycerine acetal | 17,500 | 25,000 | 15,000 | 35,000 | 25,000 |
| levulinate | | | | | |
| Ethylhexylglycerin | 1,000 | 1,000 | 1,000 | 50,000 | 2,500 |
| Ethyl glycerine acetal | 2,500 | 2,500 | 2,500 | 50,000 | 2,500 |
| levulinate plus | | | | | |
| Ethylhexylglycerin | | | | | |
| (mixture 50:50) | | | | | |
| | Synergy Index [SI = (MICmix × PA)/ | | | | |
| | MICA + (MICmix × PB)/MICB] | | | | |
| | 1.32 | 1.30 | 1.33 | 1.21 | 0.55 |

For the tested antimicrobial component, synergistic effects regarding the antimicrobial efficacy were found with SI values below 1. For a mixture of 50%: 50% of Ethyl glycerine acetal levulinate and Ethylhexylglycerine the respective MIC values were determined, resulting in a Synergy Index of 0.55 against Escherichia coli. This means that this combination is particularly effective against Escherichia coli. This means that with the addition of Ethyl glycerine acetal levulinate, the concentration of the antimicrobial component can be reduced while the same antimicrobial effect can be obtained. Hence, the use of Ethyl glycerine acetal levulinate allows for the use of less antimicrobial component in a food, cosmetic or pharmaceutical composition or home care product for achieving the same antimicrobial effect compared to a food, cosmetic or pharmaceutical composition or home care product comprising the same antimicrobial component but without the use of Ethyl glycerine acetal levulinate.

### FORMULATION EXAMPLES

The following formulations according to the present invention were prepared:
Cream O/W
Hand and Body Cream
Daily face cream, SPF 20
Body lotion
Antibacterial body lotion, sprayable
Barrier repair cream
Skin soothing lotion
Baby Nappy Rash Cream w/o
Sunscreen lotion (o/w; broadband protection)
Sun protection soft cream (w/o), SPF 40
Clear Anti Acne Wipe
PEG-free Wet Wipe
Baby Soft Wet Wipes
Intimate Wipes
After-Shave Wipes
Biotic Acne Control Gel
Anti-wrinkle gel
Cleansing Micellar Gel
Clear Beard Gel
Sprayable Anti Cellulite Gel
Aloe Vera Gel
Antidandruff Shampoo
Hair Conditioner, rinse-off
Solid Shampoo

In the following formulation examples the following five perfume oils PFO1 PFO2, PFO3, PFO4 or PFO5 were each used as fragrance.

TABLE F1
Composition of perfume oil 1; PO1 (amounts in ‰ by weight)

| Ingredients | Amount |
|---|---|
| ALDEHYDE C14 SO-CALLED | 2 |
| ALLYL AMYL GLYCOLATE 10% DPG | 5 |
| ANISIC ALDEHYDE PURE | 5 |
| APPLE OLIFFAC TYPE | 10 |
| Benzylacetate | 50 |
| BERGAMOT IDENTOIL ® COLOURLESS | 15 |
| CANTHOXAL | 5 |
| CETALOX 10% IPM | 3 |
| CITRONELLOL 950 | 40 |
| DAMASCENONE TOTAL 1% DPG | 5 |
| DAMASCONE ALPHA 10% DPG | 5 |
| DAMASCONE DELTA 10% DPG | 2 |
| DIMETHYL BENZYL CARBINYL BUTYRATE | 2 |
| DIPROPYLENE GLYCOL | 178 |
| EBANOL | 2 |
| ETHYL DECADIENOATE TRANS CIS-2.4 10% IPM | 2 |
| FLOROSA | 5 |
| FRAMBINON ® 10% DPG | 7 |
| GALAXOLIDE 50% IN IPM | 100 |
| GALBEX TYPE BASE | 1 |
| GERANYL ACETATE PURE | 2 |
| HEDIONE | 30 |
| HELIOTROPIN | 10 |
| HEXENYL ACETATE CIS-3 10% DPG | 1 |
| HEXENYL SALICYLATE CIS-3 | 5 |
| HEXYL CINNAMIC ALDEHYDE ALPHA | 70 |
| HEXYL SALICYLATE | 50 |
| HYDROXY CITRONELLAL | 10 |
| ISO E SUPER | 15 |
| ISORALDEINE 70 | 20 |
| LEAFOVERT ® | 1 |
| LILIAL | 60 |
| LINALOOL | 60 |
| LINALYL ACETATE | 20 |
| LYRAL | 7 |
| MANZANATE | 2 |
| PHENOXANOL | 7 |
| PHENYLETHYL ALCOHOL | 120 |
| SANDAL MYSORE CORE | 2 |
| SANDRANOL ® | 7 |
| STYRALYL ACETATE | 3 |
| TAGETES RCO 10% TEC | 2 |
| TERPINEOL PURE | 20 |
| TETRAHYDROGERANIOL 10% DPG | 5 |
| TONALIDE | 7 |
| VERTOCITRAL 10% DPG | 5 |
| VERTOFIX | 15 |
| Total: | 1000 |

TABLE F2
Composition of perfume oil 2; PO2 (amounts in ‰ by weight)

| Ingredients | Amount |
|---|---|
| Acetophenone. 10% in DPG | 10 |
| n-Undecanal | 5 |
| Aldehyde C14 (peach aldehyde) | 15 |
| Allylamyl glycolate, 10% in DPG | 20 |
| Amyl salicylate | 25 |
| Benzyl acetate | 60 |
| Citronellol | 80 |
| d-Limonene | 50 |
| Decenol trans-9 | 15 |
| Dihydromyrcenol | 50 |
| Dimethylbenzylcarbinyl acetate | 30 |
| Diphenyloxide | 5 |
| Eucalyptol | 10 |
| Geraniol | 40 |
| Nerol | 20 |
| Geranium oil | 15 |
| Hexenol cis-3. 10% in DPG | 5 |
| Hexenyl salicylate cis-3 | 20 |
| Indole. 10% in DPG | 10 |
| Alpha-ionone | 15 |
| Beta-ionone | 5 |
| Lilial ® (2-methyl-3-(4-tert-butyl-phenyl)propanal) | 60 |
| Linalool | 40 |
| Methylphenyl acetate | 10 |
| Phenylethyl alcohol | 275 |
| Styrolyl acetate | 20 |
| Terpineol | 30 |
| Tetrahydrolinalool | 50 |
| Cinnamyl alcohol | 10 |
| Total: | 1000 |

TABLE F3
Composition of perfume oil 3; PO3 (amounts in ‰ by weight)

| Ingredients | Amount |
|---|---|
| Benzyl acetate | 60 |
| Citronellyl acetate | 60 |
| Cyclamenaldehyde (2-methyl-3-(4- | 20 |
| isopropylphenyl)propanal | |
| Dipropylene glycol (DPG) | 60 |
| Ethyllinalool | 40 |
| Florol (2-isobutyl-4-methyltetrahydro-2H-pyran-4-ol) | 30 |
| Globanone ® [(E/Z)-8-cyclohexadecen-1-one] | 180 |
| Hedione ® (methyldihydrojasmonate) | 140 |
| Hexenyl salicylate. cis-3 | 10 |
| Vertocitral (2.4-dimethyl-3- | 5 |
| cyclohexenecarboxaldehyde) | |
| Hydratropaldehyde. 10% in DPG | 5 |
| Isodamascone (1-(2.4.4-trimethyl-2-cyclohexen-1-yl)- | 5 |
| 2-buten-1-one. 10% in DPG | |
| Isomuscone (cyclohexadecanone) | 40 |
| Jacinthaflor (2-methyl-4-phenyl-1.3-dioxolane) | 10 |
| Cis-jasmone. 10% in DPG | 20 |
| Linalool | 50 |
| Linalyl acetate | 30 |
| Methyl benzoate. 10% in DPG | 25 |
| para-Methyl cresol. 10% in DPG | 10 |
| Nerol | 20 |
| Phenylpropylaldehyde | 5 |
| 2-Phenylethyl alcohol | 82 |
| Tetrahydrogeraniol | 13 |
| 2.2-Dimethyl-3-cyclohexyl-1-propanol | 80 |
| Total: | 1000 |

TABLE F4
Composition of perfume oil 4; PO4 (amounts in ‰ by weight)

| Ingredients | Amount |
|---|---|
| AMBRETTOLIDE (MACRO) | 10 |
| AMBROXIDE 10% in IPM | 10 |
| BENZYL ACETATE | 20 |
| BENZYL SALICYLATE | 15 |
| BERGAMOT OIL. bergapten-free | 60 |
| CALONE ® 1951 10% in DPG | 15 |
| COUMARIN | 5 |
| CYCLOGALBANATE ® 10% in DPG | 10 |
| ALPHA -DAMASCONE 1% in DPG | 20 |
| DIHYDROMYRCENOL | 10 |
| ETHYL LINALOOL | 75 |
| ETHYL LINALYLACETATE | 50 |
| ETHYL MALTOL 1% in DEP | 10 |
| ETHYLENE BRASSYLATE (MACRO) | 80 |
| FLOROSA | 40 |
| GERANYLACETATE | 10 |
| HEDIONE ® HC/30 | 35 |
| HEDIONE ® | 210 |
| HELIONAL ® | 15 |
| HELVETOLIDE ® (ALICYC) | 30 |
| HEXENYLSALICYLATE CIS-3 | 20 |
| ISO E SUPER ® | 40 |
| LEAFOVERT ® 10% in DEP | 10 |
| LILIAL ® | 80 |
| LYRAL ® | 20 |
| MANDARIN OIL | 10 |
| STYRALYL ACETATE | 5 |
| SYMROSE ® | 15 |
| VANILLIN 10% in DEP | 20 |
| DIPROPYLENE GLYCOL (DPG) | 50 |
| TOTAL: | 1000 |

TABLE F5
Composition of perfume oil 5; PO5 (amounts in ‰ by weight)

| Ingredients | Amount |
|---|---|
| AMAROCITE ® | 10 |
| AMBROCENIDE ® 10% in DPG | 5 |
| AMBROXIDE | 15 |
| AURELIONE ® (7/8-Cyclohexadecenone) (MACRO) | 70 |
| BERGAMOT OIL. bergapten-free | 90 |
| CALONE ® 1951 10% in DPG | 20 |
| CARAWAY OIL | 10 |
| CITRAL | 20 |
| COUMARIN | 10 |
| ALPHA-DAMASCONE 1% in DPG | 15 |
| DIHYDROMYRCENOL | 70 |
| ESTRAGON OIL | 10 |
| ETHYL LINALOOL | 100 |
| ETHYL LINALYLACETATE | 90 |
| EUGENOL | 10 |
| EVERNYL ® | 5 |
| FRUCTATE ® | 5 |
| GERANIUM OIL | 5 |
| HEDIONE ® HC/30 | 100 |
| HELIONAL ® | 10 |
| INDOLE 10% in DPG | 5 |
| ISO E SUPER ® | 100 |
| KEPHALIS ® | 5 |
| LAVENDER OIL | 40 |
| CITRUS OIL | 80 |
| LILIAL ® | 30 |
| MANDARIN OIL | 20 |
| MUSCENONE (MACRO) | 5 |
| SANDRANOL ® | 10 |
| VANILLIN 10% in DPG | 5 |
| DIPROPYLENE GLYCOL | 30 |
| TOTAL: | 1000 |

Cosmetic formulations (compositions)—amounts are indicated as % by weight for all formulations.

TABLE F6
Cream o/w

| Ingredients | INCI | Amount |
|---|---|---|
| Dracorin ® CE | Glyceryl Stearate Citrate | 1.0 |
| Lanette ® O | Cetearyl Alcohol | 2.0 |
| Cutina ® GMS-V | Glyceryl Stearate | 1.0 |
| Tegosoft ® MM | Myristyl Myristate | 1.0 |
| Hydrolite ® 6 | 1,2-Hexanediol | 1.0 |
| Xiameter ® PMX-0246, | Cyclohexasiloxane (and) | 0.5 |
| Cyclosiloxane | Cyclopentasiloxane | |
| Dragoxat ® 89 | Ethylhexyl Isononanoate | 2.0 |
| PCL-Liquid ® 100 | Cetearyl Ethylhexanoate | 4.0 |
| Neutral Oil | Caprylic/Capric Triglyceride | 4.0 |
| Carbopol ® Ultrez 21 | Acrylates/C10-30 Alkyl | 0.2 |
| | Acrylate Crosspolymer | |
| Keltrol ® CG-T | Xanthan Gum | 0.1 |
| Water | Water (Aqua) | ad 100 |
| Glycerol 99.5 P. | Glycerol | 3.0 |
| 1,2-Propylene Glycol 99 P GC | Propylene Glycol | 2.0 |
| Sodium Benzoate | Sodium Benzoate | 0.2 |
| Sodium Hydroxide 10% | Aqua, Sodium Hydroxide | 0.5 |
| aqueous solution | | |
| Perfume oil PO1, PO2, | Perfume | 0.3 |
| PO3, PO4 or PO5 | | |
| SymSave ® H | Hydroxyacetophenone | 0.5 |
| Hydrolite ® 5 green | Pentylene Glycol | 0.5 |
| Ethyl Glycerine Acetal | Ethyl Glycerine Acetal | 0.5 |
| Levulinate | Levulinate | |

TABLE F7
Hand and body cream

| Ingredients | INCI | Amount |
|---|---|---|
| Dracorin ® GOC | Glyceryl Oleate Citrate, | 2.0 |
| | Caprylic/Capric Triglyceride | |
| PCL-Solid | Stearyl Heptanoate, Stearyl | 2.5 |
| | Caprylate | |
| Lanette ® O | Cetearyl Alcohol | 1.5 |
| Cutina ® GMS-V | Glyceryl Stearate | 1.0 |
| Dragoxat ® 89 | Ethylhexyl Isononanoate | 3.0 |
| PCL-Liquid ® 100 | Cetearyl Ethylhexanoate | 7.0 |
| Isodragol ® | Triisononanoin | 4.0 |
| Xiameter ® PMX-0345 | Cyclopentasiloxane (and) | 0.5 |
| Cyclosiloxane | Cyclohexasiloxane | |
| Water | Water (Aqua) | ad 100 |
| Carbopol ® Ultrez 21 | Acrylates/C10-30 Alkyl | 0.2 |
| | Acrylate Crosspolymer | |
| Keltrol ® CG-RD | Xanthan Gum | 0.1 |
| Glycerol 85 P. | Glycerol, Aqua | 3.0 |
| DragoBetaGlucan | Water (Aqua), Butylene | 1.5 |
| | Glycol, Glycerol, Avena | |
| | Sativa (Oat) Kernel Extract | |
| Potassium Sorbate | Potassium Sorbate | 0.1 |
| Sodium Hydroxide 10% | Aqua, Sodium Hydroxide | 0.5 |
| solution | | |
| Perfume oil PO1, PO2, | Perfume | 0.2 |
| PO3, PO4 or PO5 | | |
| Euxyl ® K300 | Methyl-, Butyl-, Ethyl-, | 0.3 |
| | Propyl, Isobutylparaben, | |
| | Phenoxyethanol | |
| Hydrolex ™E | Ethylhexylglycerin | 1.0 |
| Ethyl PG-Acetal Levulinate | Ethyl PG-Acetal Levulinate | 1.0 |
| Glyceryl Caprate | Glyceryl Caprate | 0.2 |
| Sorbitan Caprylate | Sorbitan Caprylate | 0.1 |

TABLE F8
Daily face cream SPF 20

| Ingredients | INCI | Amount |
|---|---|---|
| SymOcide ® PH | Phenoxyethanol, | 1.0 |
| | Hydroxyacetophenone, Caprylyl | |
| | Glycol, Water (Aqua) | |
| Ascorbyl Palmitate | Ascorbyl Palmitate | 0.1 |
| Biotive L-Arginine | Arginine | 0.2 |
| Buriti oil | Mauritia Flexuosa Fruit Oil | 1.0 |
| Cocoa butter | Theobroma Cacao (Cocoa) | 2.0 |
| | Seed Butter | |
| Dimethicone | Dimethicone | 0.5 |
| Disodium EDTA | Disodium EDTA | 0.1 |
| Dragosantol 100 | Bisabolol | 0.1 |
| Dragoxat ® 89 | Ethylhexyl Isononanoate | 5.0 |
| Emulsiphos | Potassium Cetyl Phosphate, | 2.0 |
| | Hydrogenated Palm Glycerides | |
| Glycerin | Glycerin | 3.0 |
| Hydrolex ™ E | Ethylhexylglycerin | 0.5 |
| Isoadipate | Diisopropyl Adipate | 5.0 |
| Jojoba Wax Flakes | Hydrogenated Jojoba Oil | 1.0 |
| Keltrol CG-T | Xanthan Gum | 0.1 |
| Lanette O | Cetearyl Alcohol | 5.0 |
| Lanette 16 | Cetyl Alcohol | 1.0 |
| Lanette 22 | Behenyl Alcohol | 1.0 |
| Neo Heliopan ® 357 | Butyl Methoxydibenzoylmethane | 3.0 |
| Neo Heliopan ® HMS | Homosalate | 10.0 |
| Neo Heliopan ® Hydro | Phenylbenzimidazole Sulfonic | 8.0 |
| used as a 25% aq, Solution | Acid | |
| neutralized by arginine | | |
| Diethylamino | Diethylamino | 1.5 |
| hydroxybenzoyl | hydroxybenzoyl | |
| hexyl benzoate | hexyl benzoate | |
| Neo Heliopan ® OS | Ethylhexyl Salicylate | 5.0 |
| Orgasol Caresse | Polyamide-5 | 1.0 |
| Perfume oil PO1, PO2, | Perfume | 0.1 |
| PO3, PO4 or PO5 | | |
| Shea butter | Butyrospermum Parkii (Shea) | 3.0 |
| | Butter | |
| Ethyl PG-Acetal Levulinate | Ethyl PG-Acetal Levulinate | 0.6 |
| Simugel EG | Sodium Acrylate/Sodium | 1.0 |
| | Acryloyldimethyl Taurate | |
| | Copolymer, Isohexadecane, | |
| | Polysorbate 80 | |
| SymFinity ® 1298 | Echinacea Purpurea Extract | 0.1 |
| SymMatrix ® | Maltodextrin, Rubus Fructicosus | 0.1 |
| | (Blackberry) Leaf Extract | |
| SymSitive ® 1609 | Pentylene Glycol, 4-t- | 1.0 |
| | Butylcyclohexanol | |
| Tegosoft TN | C12-15 Alkyl Benzoate | 4.0 |
| Hydrolite-8 | Caprylyl Glycol | 0.5 |
| Ethyl Glycerine Acetal | Ethyl Glycerine Acetal | 0.8 |
| Levulinate | Levulinate | |
| Levulinic Acid | Levulinic Acid | 0.2 |
| TEA-salicylate | TEA-salicylate | 0.1 |
| Water | Water (aqua) | ad 100 |

TABLE F9
Body lotion

| Ingredients | Amount |
|---|---|
| Cetearyl Alcohol | 2.0 |
| Ethylhexyl Isononanoate | 5.0 |
| Cetearyl Ethylhexanoate, Isopropyl Myristate | 3.0 |
| Glyceryl Oleate Citrate, Caprylic/Capric Triglyceride | 4.0 |
| Water (Aqua) | ad 100 |
| Hydroxyacetophenone | 0.2 |
| Carbomer | 0.3 |
| DMDM Hydantoin | 0.1 |
| Anisic Acid | 0.3 |
| Propylene Glycol | 5.0 |
| Pentylene Glycol | 2.0 |
| Sodium Hydroxide 30% aqueous solution | 0.3 |
| Perfume oil PO1, PO2, PO3, PO4 or PO5 | 0.3 |
| Triethylene Glycol, Imidazolidinyl Urea, Methylparaben, | 0.2 |
| Propylparaben, Dehydroacetic Acid | |
| Tetrasodium Glutamate Diacetate | 0.1 |
| Ethyl Glycerine Acetal Levulinate | 4.0 |

TABLE F10
Antibacterial body lotion, sprayable

| Ingredients | INCI | Amount |
|---|---|---|
| Dow Corning 345 Fluid | Cyclomethicone | 0.5 |
| Dracorin ® GOC | Glyceryl Oleate Citrate, | 2.0 |
| | Caprylic/Capric Triglyceride | |
| Drago-Calm | Water, Glycerin, Avena Sativa | 1.0 |
| | (Oat) Kernel Extract | |
| Dragosantol ® 100 | Bisabolol | 0.1 |
| Perfume oil PO1, PO2, | Perfume | 0.3 |
| PO3, PO4 or PO5 | | |
| Hydrolite ®-5 | Pentylene Glycol | 5.0 |
| Neutral Oil | Caprylic/Capric Triglyceride | 4.0 |
| Paraffin Oil | Mineral Oil | 4.0 |
| PCL Liquid 100 | Cetearyl Ethylhexoate | 7.0 |
| Pemulen TR-2 | Acrylates/C10-30 Alkyl | 0.2 |
| | Acrylate Crosspolymer | |
| Sodium Hydroxide (10% | Sodium Hydroxide | 0.4 |
| aqueous sol.) | | |
| SymDeo ® MPP | Dimethyl Phenylbutanol | 0.5 |
| SymRelief ® 100 | Bisabolol, Zingiber Officinale | 0.1 |
| | (Ginger) Root Extract | |
| Ethyl PG-Acetal Levulinate | Ethyl PG-Acetal Levuliate | 1.0 |
| Ethyl Glycerine Acetal | Ethyl Glycerine Acetal | 3.0 |
| Levuliante | Levulinate | |
| Caprylhydroxamic Acid | Caprylhydroxamic Acid | 0.2 |
| Dehydracetic Acid | Dehydracetic Acid | 0.1 |
| SymSave ® H | 4-Hydroxyacetophenone | 0.2 |
| Water demineralized | Water (aqua) | ad 100 |
| Hydrolite ® 7 green | 1,2-heptanediol | 0.8 |

TABLE F11
Barrier repair cream

| Ingredients | INCI | Amount |
|---|---|---|
| Abil 350 | Dimethicone | 0.5 |
| Allantoin | Allantoin | 0.25 |
| Ceramide BIO* | Cetylhydroxyproline | 0.5 |
| | Palmitamide | |
| Dracorin ® CE | Glyceryl Stearate Citrate | 1.5 |
| Dragoxat ® 89 | Ethylhexylisononanoate | 2.0 |
| Emulsiphos ® | Potassium Cetyl Phosphate, | 2.0 |
| | Hydrogenated Palm Glycerides | |
| Extrapone ® Rosemary | Glycerin, Water (Aqua), | 0.5 |
| GW | Rosmarinus officinalis | |
| | (Rosemary) Leaf Extract | |
| Ethyl Glycerine Acetal | Ethyl Glycerine Acetal | 2.0 |
| Levulinate | Levulinate | |
| Perfume oil PO1, PO2, | Perfume | 0.1 |
| PO3, PO4 or PO5 | | |
| Glycerol 85% | Glycerin | 3.0 |
| Glyceryl Stearate | Glyceryl Stearate | 2.0 |
| Hydroviton ® 24 | Water, Glycerin, Sodium | 1.0 |
| | Lactate, TEA Lactate, Serine, | |
| | Lactic Acid, Urea, Sorbitol, | |
| | Sodium Chloride, Lauryl | |
| | Diethylenedi-aminoglycine, | |
| | Lauryl Aminopropyl-glycine, | |
| | Allantoin | |
| Isodragol ® | Triisononanoin | 3.0 |
| Lanette O | Cetearyl Alcohol | 2.0 |
| NaOH 10% sol, | Sodium Hydroxide | 0.3 |
| Neutral Oil | Caprylic/Capric Triglyceride | 10.0 |
| SymCalmin ® | Pentylene Glycol, Butylene | 1.0 |
| | Glycol, Hydroxyphenyl | |
| | Propamidobenzoic Acid | |
| SymSave ® H | Hydroxyacetophenone | 0.3 |
| SymRepair ® 100 | Hexyldecanol, Bisabolol, | 2.0 |
| | Cetylhydroxyproline | |
| | Palmitamide, Stearic Acid, | |
| | Brassica Campestris | |
| | (Rapeseed) Sterols | |
| SymDiol ® 68 T | Caprylyl glycol, 1,2-Hexanediol, | 1.0 |
| | Tropolone | |
| Tegosoft PC 31 | Polyglyceryl 3- Caprate | 0.3 |
| Tocopherol Acetate | Tocopheryl Acetate | 0.3 |
| Water (demineralized) | Water (Aqua) | ad 100 |
| Trisodium Ethylenediamine | Trisodium Ethylenediamine | 0.1 |
| Disuccinate | Disuccinate | |
| Phenoxyethanol | Phenoxyethanol | 0.5 |
| Hydrolex ™ E | Ethylhexylglycerin | 0.75 |

TABLE F12
Skin soothing lotion

| Ingredients | INCI | Amount |
|---|---|---|
| Allantoin | Allantoin | 0.2 |
| Carbopol Ultrez-10 | Carbomer | 0.1 |
| Ceramide BIO* | Cetylhydroxyproline | 0.1 |
| | Palmitamide | |
| Citric Acid 10% sol, | Citric Acid | 0.4 |
| Emulsiphos ® | Potassium Cetyl Phosphate, | 2.0 |
| | Hydrogenated Palm Glycerides | |
| Extrapone ® Green Tea GW | Glycerin, Water (Aqua), | 0.2 |
| | Camellia Sinensis Leaf Extract | |
| Hydrolite ® 5 green | Pentylene Glycol | 1.5 |
| Ethyl PG-Acetal Levulinate | Ethyl PG-Acetal Levulinate | 2.5 |
| Extrapone ® Rosemary GW | Glycerin, Water (Aqua), | 0.3 |
| | Rosmarinus officinalis | |
| | (Rosemary) Leaf Extract | |
| Perfume oil PO1, PO2, | Perfume | 0.3 |
| PO3, PO4 or PO5 | | |
| Glycerol 85% | Glycerin, Aqua | 2.0 |
| Glyceryl Stearate | Glyceryl Stearate | 2.0 |
| Isodragol ® | Triisononanoin | 2.0 |
| Keltrol RD | Xanthan Gum | 0.1 |
| Lanette O | Cetearyl Alcohol | 3.0 |
| Neo PCL wssl, N | Trideceth-9, PEG-5 | 1.0 |
| | Ethylhexanoate, Water | |
| PCL Liquid 100 | Cetearyl Ethylhexanoate | 5.0 |
| PCL Solid | Stearyl Heptanoate, Stearyl | 2.0 |
| | Caprylate | |
| Phenoxyethanol | Phenoxyethanol | 0.8 |
| Propylene Glycol | Propylene Glycol | 5.0 |
| Sodium Hydroxide 10% | Sodium Hydroxide | 0.3 |
| aqueous solution | | |
| Sodium Methylparaben | Sodium Methylparaben | 0.2 |
| SymCalmin ® | Pentylene Glycol, Butylene | 2.0 |
| | Glycol, Hydroxyphenyl | |
| | Propamidobenzoic Acid | |
| SymMatrix ® | Maltodextrin, Rubus Fruticosus | 0.1 |
| | (Blackberry) Leaf Extract | |
| SymOcide ® C | o-cymen-5-ol | 0.1 |
| Caprylhydroxamic Acid | Caprylhydroxamic acid | 0.4 |
| SymSitive ®1609 | Pentylene Glycol, 4-t- | 1.5 |
| | Butylcyclohexanol | |
| Water (demineralized) | Water (Aqua) | ad 100 |

TABLE F13
Baby Nappy Rash Cream w/o

| Ingredients | Amount |
|---|---|
| SymOcide PH | 1.0 |
| Phenoxyethanol, Hydroxyacetophenone, Caprylyl Glycol, Water | |
| (Aqua) | |
| Cupuaçu butter | 1.0 |
| Theobroma Grandiflorum Seed Butter | |
| Cutina HR Powder | 1.5 |
| Hydrogenated Castor Oil | |
| Dehymuls PGPH | 5.0 |
| Polyglyceryl-2 Dipolyhydroxystearate | |
| Glycerin | 5.0 |
| Glycerin | |
| Jojoba oil | 5.0 |
| Simmondsia Chinensis (Jojoba) Seed Oil | |
| Magnesium Sulfate Hepta Hydrate | 0.5 |
| Magnesium Sulfate | |
| Monomuls 90-O18 | 1.0 |
| Glyceryl Oleate | |
| Neutral oil | 8.0 |
| Caprylic/capric triglyceride | |
| PCL Liquid 100 | 5.0 |
| Cetearyl Ethylhexanoate | |
| SymCalmin | 1.0 |
| Butylene Glycol, Pentylene Glycol, Hydroxyphenyl | |
| Propamidobenzoic Acid | |
| Benzyl Alcohol | 0.3 |
| Tetrasodium EDTA | 0.1 |
| Tetrasodium EDTA | |
| Titan dioxide | 4.0 |
| Titan dioxide | |
| Water | ad 100 |
| Aqua | |
| Wheat germ oil | 2.0 |
| Triticum Vulgare (Wheat) Germ Oil | |
| Zinc oxide | 10.0 |
| Zinc oxide | |
| Perfume oil PO1, PO2, PO3, PO4 or PO5 | 0.1 |
| Perfume | |
| Itaconic Acid | 0.3 |
| Ethyl Glycerine Acetal Levulinate | 0.8 |
| Ethyl PG-Acetal Levulinate | 0.7 |

TABLE F14
Sunscreen lotion (o/w; broadband protection)

| Ingredients | INCI | Amount |
|---|---|---|
| Benzyl Salicylate | Benzyl Salicylate | 0.5 |
| Carbopol Ultrez-10 | Carbomer | 0.2 |
| Dow Corning 246 Fluid | Cyclohexasiloxane and | 2.0 |
| | Cyclopentasiloxane | |
| Dragosantol ® 100* | Bisabolol | 0.3 |
| EDETA BD | Disodium EDTA | 0.1 |
| Emulsiphos ® | Potassium Cetyl Phosphate, | 1.5 |
| | Hydrogenated Palm Glycerides | |
| Ethyl Glycerine Acetal | Ethyl Glycerine Acetal | 1.0 |
| Levulinate | Levulinate | |
| Perfume oil PO1, PO2, | Perfume | 0.4 |
| PO3, PO4 or PO5 | | |
| Frescolat ® MGA | Menthone Glycerol Acetal | 0.3 |
| Glycerol 85% | Glycerin | 4.7 |
| Keltrol RD | Xanthan Gum | 0.2 |
| Lanette O | Cetearyl Alcohol | 1.0 |
| Neo Heliopan ® 357 | Butyl Methoxy-dibenzoyl- | 1.0 |
| | methane | |
| Neo Heliopan ® AP | Disodium Phenyl | 10.0 |
| (10% as sodium salt) | Dibenzimidazole Tetrasulfonate | |
| Neo Heliopan ® AV | Ethylhexyl Methoxy-cinnamate | 3.0 |
| Neo Heliopan ® Hydro | Phenylbenz-imidazole Sulfonic | 6.7 |
| (15% as sodium salt) | Acid | |
| Neo Heliopan ® MBC | 4-Methylbenzyl-idene Camphor | 1.5 |
| Neo Heliopan ® OS | Ethylhexyl Salicylate | 5.0 |
| Neutral Oil | Caprylic/Capric Triglyceride | 2.0 |
| SymMatrix ® | Maltodextrin, Rubus Fruticosus | 0.3 |
| | (Blackberry) Leaf Extract | |
| Methylisothiazolinone | Methylisothiazolinone | 0.1 |
| SymOcide ® BHO | Hydroxyacetophenone, Benzyl | 0.5 |
| | alcohol, Caprylyl glycol, Aqua | |
| Tegosoft TN | C12-15 Alkyl Benzoate | 5.0 |
| Tocopherol Acetate | Tocopheryl Acetate | 0.5 |
| Triethanolamine, 99% | Triethanolamine | 0.5 |
| Water (demineralized) | Water (Aqua) | ad 100 |
| Hydrolite ® 6 | 1,2 Hexanediol | 0.5 |
| SymSave ® H | Hydroxyacetophenone | 0.4 |

TABLE F15
Sun protection soft cream (w/o), SPF 40

| Ingredients | INCI | Amount |
|---|---|---|
| Dehymuls PGPH | Polyglyceryl-2 | 5.0 |
| | dipolyhydroxystearate | |
| Copherol 1250 | Tocopheryl acetate | 0.5 |
| Permulgin 3220 | Ozocerite | 0.5 |
| Zinc stearate | Zinc stearate | 0.5 |
| Tegosoft TN | C12-15 Alkyl benzoate | 10.0 |
| Ethyl PG-Acetal Levulinate | Ethyl PG-Acetal Levulinate | 1.2 |
| Ethyl Glycerine Acetal | Ethyl Glycerine Acetal | 3.5 |
| Levulinate | Levulinate | |
| Neo Heliopan ® E1000 | Isoamyl-p-methoxycinnamate | 2.0 |
| Neo Heliopan ® 303 | Octocrylene | 5.0 |
| Neo Heliopan BMT | Bis-Ethylhexyloxyphenol | 2.0 |
| | Methoxyphenyl Triazine | |
| Ethylhexyl Triazone | Ethylhexyl Triazone | 2.0 |
| Neo Heliopan ® MBC | 4-Methylbenzylidene camphor | 3.0 |
| Zinc oxide, neutral | Zinc oxide | 5.0 |
| Water, distilled | Water (aqua) | ad 100 |
| EDETA BD | Disodium EDTA | 0.1 |
| Glycerol | Glycerol | 4.0 |
| Magnesium sulfate | Magnesium sulfate | 0.5 |
| Perfume oil PO1, PO2, PO3, | Perfume | 0.3 |
| PO4 or PO5 | | |
| Symdiol ® 68 | Hexanediol, Caprylylglycol | 0.5 |

TABLE F16
Clear Anti Acne Wipe

| Ingredients | INCI | Amount |
|---|---|---|
| Farnesol | Farnesol | 0.2 |
| Sensiva SC 50 | Ethylhexylglycerin | 0.3 |
| SymSave ® H | Hydroxyacetophenone | 0.5 |
| Phenethylalcohol | Phenethylalcohol | 0.3 |
| Isopropanol | Isopropanol | 45.0 |
| Water, distilled | Water (Aqua) | ad 100 |
| Camomile CL | Chamomilla Recutita | 1.0 |
| | (Matricaria) Flower Water, | |
| | Butylene Glycol, Pentylene | |
| | Glycol | |
| Hydrolite ® 5 green | Pentylene Glycol | 2.0 |
| Ethyl Glycerine Acetal | Ethyl Glycerine Acetal | 2.0 |
| Levulinate | Levulinate | |
| Witch Hazel-Distillate | Hamamelis Virginiana (Witch | 1.0 |
| | Hazel) Water, Water (Aqua), | |
| | Alcohol, Hamamelis Virginiana | |
| | (Witch Hazel) Extract | |
| Citric Acid 10% aqueous | Citric Acid | 0.03 |
| solution | | |
| Perfume oil PO1, PO2, | Perfume | 0.1 |
| PO3, PO4 or PO5 | | |
| Hydroxyethoxyphenyl | Hydroxyethoxyphenyl | 0.4 |
| Butanone | Butanone | |

TABLE F17
PEG-free Wet Wipe

| Ingredients | INCI | Amount |
|---|---|---|
| Tegosoft ® PC 41 | Polyglyceryl-4 Caprate | 2.0 |
| Phenethylalcohol | Phenethylalcohol | 0.5 |
| Tegosoft ® M | Isopropyl Myristate | 0.2 |
| Perfume oil PO1, PO2, PO3, | Perfume | 0.1 |
| PO4 or PO5 | | |
| Propylengycol | Propylene Glycol | 3.0 |
| Water, distilled | Water (Aqua) | ad 100 |
| Cetrimonium Bromide, 40% | Cetrimonium Bromide | 0.25 |
| Chlorphenesine | Chlorphenesine | 0.1 |
| SymSave ® H | Hydroxyacetophenone | 0.6 |
| Hydrolite ® 7 green | 1,2-heptanediol | 1.5 |
| Ethyl PG-Acetal Levulinate | Ethyl PG-Acetal Levulinate | 1.8 |

TABLE F19
Baby Soft Wet Wipes

| Ingredients | INCI | Amount |
|---|---|---|
| Mineral Oil | Paraffinum Liquidum | 4.0 |
| Ethyl PG-Acetal Levulinate | Ethyl PG-Acetal Levulinate | 2.0 |
| Isopropylpalmitat | Isopropyl Palmitate | 3.0 |
| Eumulgin B2 | Ceteareth-20 | 2.5 |
| Lanette O | Cetearyl Alcohol | 2.5 |
| Dragosantol | Bisabolol | 0.1 |
| Olive Oil | Olea Europaea (Olive) Fruit Oil | 0.5 |
| Isopropylmyristat | Isopropyl Myristate | 0.5 |
| Dow Corning 345 Fluid | Cyclomethicone | 0.2 |
| Super Hartolan | Lanolin Alcohol | 0.2 |
| Tagat L2 | PEG-20 Glyceryl Laurate | 2.5 |
| Water, distilled | Water (Aqua) | ad 100 |
| Glycerine 99.5% | Glycerin | 3.0 |
| Citric Acid Sol, aqueous | Citric Acid | 0.1 |
| solution 10% | | |
| Perfume oil PO1, PO2, PO3, | Perfume | 0.1 |
| PO4 or PO5 | | |
| Hydrolex ™ E | Ethylhexylglycerin | 0.3 |
| 1,2-heptanediol | 1,2-heptanediol | 1.0 |
| 2,3-heptanediol | 2,3-heptanediol | 0.02 |
| 1,2-octanediol | 1,2-octanediol | 0.3 |
| 2,3-octanediol | 2,3-octanediol | 0.01 |

TABLE F19
Intimate Wipes

| Ingredients | INCI | Amount |
|---|---|---|
| Dracorin ® GOC | Glyceryl Oleate Citrate, | 2.2 |
| | Caprylic/Capric Triglyceride | |
| PCL-Liquid ® 100 | Cetearyl Ethylhexanoate | 3.0 |
| SymCalmin ® | Pentylene Glycol, Butylene | 1.0 |
| | Glycol, Hydroxyphenyl | |
| | Propamidobenzoic Acid | |
| Frescolat ® X-Cool | Menthyl Ethylamido Oxalate | 0.5 |
| Perfume oil PO1, PO2, PO3, | Perfume | 0.2 |
| PO4 or PO5 | | |
| Water, distilled | Water (Aqua) | ad 100 |
| PemulenTM TR-2 Polymeric | Acrylates/C10-30 Alkyl | 0.2 |
| Emulsifier | Acrylate Crosspolymer | |
| Hydrolex ™ E | Ethylhexylglycerin | 0.2 |
| Symdiol ® 68T | Hexanediol, Caprylyl Glycol, | 0.5 |
| | Tropolone | |
| Potassium Sorbate | Potassium Sorbate | 0.1 |
| Extrapone ® Camomille GW | Glycerin, Aqua, Chamomilla, | 0.5 |
| | Recutita Flower Extract | |
| Sodium Hydroxide 10% solution | Aqua, Sodium Hydroxide | 0.45 |
| PCA ethyl cocoyl arginate | PCA ethyl cocoyl arginate | 0.1 |
| SymSave ® H | Hydroxyacetophenone | 0.2 |
| Ethyl Glycerine Acetal | Ethyl Glycerine Acetal | 0.8 |
| Levulinate | Levulinate | |

TABLE F20
After-Shave Wipes

| Ingredients | INCI | Amount |
|---|---|---|
| Acrylates/C10-30 Alkyl | Acrylates/C10-30 Alkyl | 0.1 |
| Acrylate Crosspolymer | Acrylate Crosspolymer | |
| Water, distilled | Water (Aqua) | Ad 100 |
| Sodium Hydroxide 10% solution | Aqua, Sodium Hydroxide | 0.13 |
| Sodium Anisate | Sodium Anisate | 0.3 |
| Hydrolite ® 5 green | Pentylene Glycol | 1.0 |
| Glyceryl Undecylenate | Glyceryl Undecylenate | 0.1 |
| Glycerin | Glycerin | 4.0 |
| DOWSIL ™ 2501 | Bis-PEG-18 Methyl Ether | 2.0 |
| Cosmetic Wax | Dimethyl Silane | |
| Aloe Vera | Aloe Vera | 0.6 |
| Propylene Glycol | Propylene Glycol | 0.3 |
| Witch Hazel Extract | Hamamelis Virginiana (Witch | 0.7 |
| | Hazel) Extract | |
| C12-15 Alkyl Benzoate | C12-15 Alkyl Benzoate | 2.7 |
| Dragosantol ® 100 | Bisabolol | 0.2 |
| Polysorbate-20 | Polysorbate-20 | 0.5 |
| DOWSIL ™ 9040 Silicone | Cyclopentasiloxane (and) | 3.5 |
| Elastomer Blend | Dimethicone Crosspolymer | |
| XIAMETER ™ PMX-1184 | Dimethicone (and) Trisiloxane | 5.8 |
| Silicone Fluid | | |
| Perfume oil PO1, PO2, PO3, | Perfume | 0.3 |
| PO4 or PO5 | | |
| DOWSIL ™ 9509 Silicone | Dimethicone/Vinyl | 2.0 |
| Elastomer Suspension | Dimethicone Crosspolymer | |
| | (and) C12-14 Pareth-12 | |
| Phytic Acid | Phytic Acid | 0.2 |
| Salicylic Acid | Salicylic Acid | 0.5 |
| Ethyl PG-Acetal Levulinate | Ethyl PG-Acetal Levulinate | 0.8 |
| Ethyl Glycerine Acetal | Ethyl Glycerine Acetal | 0.6 |
| Levulinate | Levulinate | |

TABLE F21
Biotic Acne Control Gel

| Ingredients | INCI | Amount |
|---|---|---|
| Water, distilled | Water (Aqua) | ad 100 |
| SymSave ® H | Hydroxyacetophenone | 0.5 |
| Carbopol ® Ultrez 21 | Acrylates/C10-30 Alkyl | 0.5 |
| Polymer | Acrylate Crossploymer | |
| Solubilizer | PEG-40 Hydrogenated Castor | 2.5 |
| | Oil, Trideceth-9, Propylene | |
| | Glycol, Aqua | |
| SymClariol ® | Decylene Glycol | 0.5 |
| SymMollient ® W/S | Trideceth-9, PEG-5 | 1.0 |
| | Isononanoate, Aqua | |
| Ethyl Glycerine Acetal | Ethyl Glycerine Acetal | 1.5 |
| Levulinate | Levulinate | |
| Hydrolite ®- 5 green | Pentylene Glycol | 5.0 |
| Dragosantol ® | Bisabolol | 0.05 |
| Farnesol | Farnesol | 0.3 |
| Ethanol | Alcohol | 5.0 |
| Flowerpone ® Lavender | PEG-40 Hydrogenated Castor | 0.5 |
| | Oil, Trideceth-9, Pentylene | |
| | Glycol, Lavandula Angustifolia | |
| | Flower Extract, Propylene | |
| | Glycol, Bisabolol | |
| SymReboot ™ L19 | Maltodextrin, Lactobacillus | 0.5 |
| | Ferment | |
| Sodium Hydroxide 10% | Aqua, Sodium Hydroxide | 1.1 |
| solution | | |
| Colour | Colour | 0.2 |
| Perfume oil PO1, PO2, | Perfume | 0.3 |
| PO3, PO4 or PO5 | | |
| Diazolidinyl Urea | Diazolidinyl Urea | 0.1 |
| Capryloyl glycine | Capryloyl glycine | 0.1 |

TABLE F22
Anti-wrinkle gel

| Ingredients | INCI | Amount |
|---|---|---|
| EMT-10 | Hydroxyethyl acrylate/sodium | 1.2 |
| | acryloyldimethyl taurate | |
| | copolymer | |
| CC | Dicaprylyl Carbonate | 2.0 |
| SpecKare ™ 3GF | Glyceryl linoleate, Glyceryl | 1.0 |
| | oleate, Glyceryl linolenate | |
| EH | Ethylhexyl Ethylhexanoate | 2.0 |
| CDM3526 | C26-28 alkyl dimethicone | 0.2 |
| SpecKareTM VEA | Tocopheryl Acetate | 0.2 |
| Glycerin | Glycerin | 8.0 |
| SpecThem ® XTG200 | Xanthan Gum | 0.18 |
| SpecThem ® SCB21 | Acrylates/c10-30 alkyl acrylate | 0.15 |
| | crosspolymer | |
| SpecKareTM ALLA | Allantoin | 0.1 |
| H-200 | Glyceryl Polyacrylate | 6.0 |
| Water, distilled | Water (Aqua) | ad 100 |
| SpecPure ® PC1(1% Liquid) | Poria cocos sclerotium extract | 2.0 |
| SpecKareTM HAL | Sodium Hyaluronate | 5.0 |
| (1% Liquid) | | |
| EDTA-2Na | Disodium EDTA | 0.1 |
| SpecKareTM NMF50 | Betaine | 2.0 |
| Triethanolamine | Triethanolamine | 0.13 |
| NK2 | Dipotassium Glycyrrhizinate | 0.1 |
| Phenylpropanol | Phenylpropanol | 0.8 |
| Perfume oil PO1, PO2, PO3, | Perfume | 0.1 |
| PO4 or PO5 | | |
| SpecPed ® Co-De BPS | Polyglyceryl-10 tristearate, | 5.0 |
| | Caprylic/capric triglyceride, | |
| | Butylene glycol, Glycerin, | |
| | Hexylene glycol, Carnosine, | |
| | Lecithin, Hydroxylated lecithin, | |
| | Cholesterol, Palmitoyl | |
| | tripeptide-5, Acetyl | |
| | tetrapeptide-5, Palmitoyl | |
| | pentapeptide-4, Aqua | |
| Hydrolex ™ E | Ethylhexylglycerin | 0.7 |
| Ethyl PG-Acetal Levulinate | Ethyl PG-Acetal Levulinate | 1.2 |

TABLE F23
Cleansing Micellar Gel

| Ingredients | INCI | Amount |
|---|---|---|
| Water, distilled | Water (Aqua) | ad 100 |
| Carbopol ® ETD 2050 | Carbomer | 0.7 |
| Polymer | | |
| Hydroviton ® PLUS 2290 | Aqua, Pentylene glycol, | 2.0 |
| | Glycerin Fructose, Urea, | |
| | Citric acid, Sodium hydroxide, | |
| | Maltose Sodium pca, Sodium | |
| | chloride Sodium lactate, | |
| | Trehalose Allantoin, Sodium | |
| | hyaluronate Glucose | |
| Ethyl Glycerine Acetal | Ethyl Glycerine Acetal | 1.8 |
| Levulinate | Levulinate | |
| Hydrolite ® 5 green | Pentylene Glycol | 1.5 |
| SymOcide ® PS | Phenoxyethanol, | 1.0 |
| | Decylene glycol, | |
| | 1,2-hexanediol | |
| Sodium Hydroxide 10% | Aqua, Sodium Hydroxide | 3.28 |
| solution | | |
| SymMollient ® W/S | Trideceth-9, PEG-5 | 1.0 |
| | Isononanoate, Aqua | |
| SymSol ® PF-3 | Aqua, Pentylene glycol, | 3.0 |
| | Sodium lauryl sulfoacetate, | |
| | Sodium oleoyl sarcosinate, | |
| | Sodium chloride, Sodium oleate | |
| Perfume oil PO1, PO2, PO3, | Perfume | 1.0 |
| PO4 or PO5 | | |
| SymVital ® AR | Zingiber officinale (ginger) | 0.2 |
| | root extract | |
| Extrapone ® Seaweed | Aqua | 1.0 |
| | Butylene glycol | |
| | Fucus vesiculosus extract | |
| Actipone ® Dandelion Juice | Glycerin | 1.0 |
| (Organic) GW | Taraxacum officinale juice | |
| | Aqua | |
| Colour I | Colour | 0.35 |
| Colour II | Colour | 0.20 |
| Caprylhydroxamic Acid | Caprylhydroxamic Acid | 0.2 |
| Phenylpropanol | Phenylpropanol | 0.2 |
| Salicylic Acid | Salicylic Acid | 0.2 |
| SymSave ® H | Hydroxyacetophenone | 0.6 |

TABLE F24
Clear Beard Gel

| Ingredients | INCI | Amount |
|---|---|---|
| Aqua/Water | Aqua | ad 100 |
| Edeta ® BD | Disodium EDTA | 0.10 |
| Glycerine | Glycerin | 3.00 |
| SymOcide ® PH | Phenoxyethanol, | 0.50 |
| | Hydroxyacetophenone, Caprylyl | |
| | glycol, Aqua | |
| Hydrolite ® 7 green | 1,2 Heptanediol | 0.15 |
| Keltrol ® CG-T | Xanthan gum | 0.10 |
| Aristoflex ® AVC | Ammonium, | 2.00 |
| | Acryloyoldimethyltaurate/vp | |
| | Copolymer | |
| KeraSym ™ Shield | Pentylene glycol, Aqua, Glycerin, | 1.00 |
| | Triticum vulgare bran extract, | |
| | 1,2-Hexanediol, Caprylyl glycol | |
| Actipone ® Arctic | Glycerin, Aqua, Rubus | 0.50 |
| Cloudberry GW | chamaemorus seedextract | |
| Hydroviton ® PLUS 2290 | Aqua, Pentylene glycol, Glycerin, | 1.00 |
| | Fructose, Urea, Citric acid | |
| | Sodium hydroxide, Maltose | |
| | Sodium pca, Sodium chloride | |
| | Sodium lactate, Trehalose | |
| | Allantoin, Sodium hyaluronate | |
| | Glucose | |
| Ethyl PG-Acetal Levulinate | Ethyl PG-Acetal Levuliate | 0.20 |
| Ethyl Glycerine Acetal | Ethyl Glycerine Acetal | 0.20 |
| Levulinate | Levulinate | |
| Propylene Glycol | Propylene glycol | 1.50 |
| Sodium Hydroxide 10% | Aqua, Sodium hydroxide | 0.15 |
| aqueous solution | | |
| SymSol ® PF-3 | Aqua, Pentylene glycol | 3.00 |
| | Sodium lauryl sulfoacetate | |
| | Sodium oleoyl sarcosinate | |
| | Sodium chloride, Sodium oleate | |
| Perfume oil PO1, PO2, | Perfume | 0.40 |
| PO3, PO4 or PO5 | | |
| Hydrolite ® 5 | Pentylene glycol | 3.76 |
| Ethanol 96% | Alcohol | 18.00 |
| Symlite G8 | Glyceryl Caprylate | 0.2 |
| Frescolat ® MGA | Menthone Glycerine Acetal | 0.25 |
| SymCalmin ® | Pentylene glycol, Butylene glycol | 0.50 |
| | Hydroxyphenyl | |
| | propamidobenzoic acid | |
| SymDeo B125 | 2-Methyl 5-Cyclohexylpentanol | 0.1 |

TABLE F25
Sprayable Anti Cellulite Gel

| Ingredients | INCI | Amount |
|---|---|---|
| Aqua/Water | Aqua | ad 100 |
| Stabileze QM | PVM/Ma Decadiene | 0.25 |
| | Crosspolymer | |
| Sodium Hydroxide 10% | Aqua | 0.4 |
| aqueous solution | Sodium hydroxide | |
| SymSave ® H | Hydroxyacetophenone | 0.3 |
| Caprylhydroxamic acid | Caprylhydroxamic acid | 0.2 |
| Coffein pure | Caffeine | 0.5 |
| Extrapone ® Horse Chestnut | Propylene Glycol, Water | 1.0 |
| | (Aqua), Aesculus | |
| | Hippocastanum (Horse | |
| | Chestnut) Seed Extract, | |
| | Glucose, Lactic Acid | |
| Hydrolite ® 5 | Pentylene Glycol | 3.0 |
| 1,3 Butylene Glycol | Butylene Glycol | 5.0 |
| Ethyl Glycerine Acetal | Ethyl Glycerine Acetal | 1.0 |
| Levulinate | Levulinate | |
| Biotive ® Esculin | Esculin | 0.3 |
| Sesquihydrate | | |
| Preservative | Methylparaben, | 0.3 |
| Ethanol 96% | Alcohol Denat, | 10.0 |
| Solubilizer | PEG-40 Hydrogenated Castor | 0.5 |
| | Oil, Trideceth-9, Water (Aqua) | |
| Perfume oil PO1, PO2, PO3, | Perfume | 0.2 |
| PO4 or PO5 | | |
| Benzyl Salicylate | Benzyl Salicylate | 0.1 |
| Chlorphenesin | Chlorphenesin | 0.1 |
| Ethyl PG-Acetal Levulinate | Ethyl PG-Acetal Levulinate | 0.4 |

TABLE F26
Aloe Vera Gel

| Ingredients | INCI | Amount |
|---|---|---|
| Aqua/Water | Aqua | ad 100 |
| Carbopol ® Ultrez 10 | Carbomer | 0.45 |
| Polymer | | |
| Glycerine 99.5% | Glycerine | 5.0 |
| Sodium Hydroxide 10% | Aqua | 0.9 |
| aqueous solution | Sodium hydroxide | |
| Extrapone ® Aloe Vera P | Propylene glycol | 2.0 |
| | Aqua, Aloe barbadensis leaf | |
| | juice powder | |
| SymGlucan ® | Aqua, Glycerin, 1,2-Hexanediol | 1.0 |
| | Caprylyl glycol, Beta-glucan | |
| SymOcide ® PS | Phenoxyethanol, Decylene glycol | 0.8 |
| | 1,2-Hexanediol | |
| Hydrolite ® 5 | Pentylene glycol | 3.0 |
| Hydrolex ™ E | Ethylhexylglycerin | 0.4 |
| Perfume oil PO1, PO2, | Perfume | 0.2 |
| PO3, PO4 or PO5 | | |
| Solubilizer | Peg-40 hydrogenated castor oil | 2.5 |
| | Trideceth-9, Propylene glycol | |
| | Aqua | |
| Butylene Glycol | Butylene glycol | 1.0 |
| Ethyl Glycerine Acetal | Ethyl Glycerine Acetal | 1.4 |
| Levulinate | Levulinate | |
| Chlorhexidine Digluconate | Chlorhexidine Digluconate | 0.1 |
| Glyceryl Laurate | Glyceryl Laurate | 0.1 |

TABLE F27
Antidandruff Shampoo

| Ingredients | INCI | Amount |
|---|---|---|
| Water, distilled | Water (Aqua) | ad 100 |
| Polymer JR 400 | Polyquaternium-10 | 0.4 |
| Texapon ® NSO IS | Sodium Laureth Sulfate | 40.0 |
| Farnesol | Farnesol | 0.1 |
| Dehyton K | Cocamidopropyl Betaine | 8.0 |
| Plantacare 2000 UP | Decyl Glucoside | 2.0 |
| Sodium Methylparaben | Sodium Methylparaben | 0.3 |
| Citric Acid 10% solution | Citric Acid | 0.8 |
| Frescolat ® X-cool | Menthyl Ethylamido Oxalate | 0.5 |
| SymTriol ® | Caprylyl Glycol, 1,2-Hexanediol, | 0.8 |
| | Methylbenzyl Alcohol | |
| Crinipan ® AD | Climbazole | 0.5 |
| Ethyl PG-Acetal | Ethyl PG-Acetal | 0.6 |
| Levulinate | Levulinate | |
| Ethyl Glycerine Acetal | Ethyl Glycerine Acetal | 0.75 |
| Levulinate | Levulinate | |
| SymMollient ® W/S | Trideceth-9, PEG-5 | 2.0 |
| | Isononanoate, Water (Aqua) | |
| Tinogard ® Q | Tri(tetramethylhy- | 0.02 |
| | droxypiperodonol) Citrate | |
| Sodium Chloride | Sodium Chloride | 0.5 |
| Hydrolex ™ E | Ethylhexylglycerin | 0.8 |
| Colour I | Colour | 0.3 |
| Colour II | Colour | 0.1 |
| Perfume oil PO1, PO2, | Perfume | 0.4 |
| PO3, PO4 or PO5 | | |
| Octopirox | Octopirox | 0.1 |

TABLE F28
Hair Conditioner, rinse-off

| Ingredients | INCI | Amount |
|---|---|---|
| Lanette O | Cetearyl Alcohol | 4.0 |
| Mineral Oil | Paraffinum Liquidum | 1.0 |
| Ethyl Glycerine Acetal | Ethyl Glycerine Acetal | 1.0 |
| Levulinate | Levulinate | |
| Ethyl PG Acetal Levulinate | Ethyl PG-Acetal Levulinate | 1.4 |
| Genamin KDM-P | Behentrimonium Chloride | 1.0 |
| Dow Corning 556 Fluid | Phenyl Trimethicone | 1.0 |
| Neo Heliopan ® BB | Benzophenone - 3 | 0.1 |
| Crinipan ® AD | Climbazole | 0.1 |
| Water, distilled | Water (Aqua) | ad 100 |
| Glycerine 99.5 P. | Glycerin | 6.0 |
| Preservative | Phenoxyethanol, | 0.8 |
| | Methylparaben, Ethylparaben, | |
| | Butylparaben, Propylparaben, | |
| | Isobutylparaben | |
| Extrapone Bamboo P | Propylene Glycol, Water | 0.5 |
| | (Aqua), Butylene Glycol, | |
| | Bambusa Vulgaris Shoot | |
| | Extract | |
| SymSave ® H | Hydroxyacetophenone | 0.7 |
| Sodium Hydroxide 10% solution | Aqua, Sodium Hydroxide | 0.4 |
| Colour I | Colour | 0.6 |
| Colour II | Colour | 0.3 |
| Perfume oil PO1, PO2, PO3, | Perfume | 0.6 |
| PO4 or PO5 | | |
| Methylchloroisothiazolinone | Methylchloroisothiazolinone | 0.1 |
| Glyceryl Laurate | Glyceryl Laurate | 0.1 |

1. A composition comprising:
(a) an effective amount of at least one antimicrobial agent;
(b) an effective amount of an alkyl ketal ester compound represented by the general formula (I) 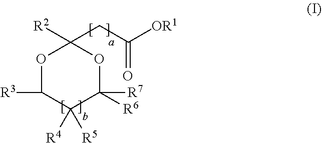
wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof; and
(c) optionally at least one active substance for food, a cosmetic or pharmaceutical composition or a home care product and/or an additive.

2. The composition according to claim 1, wherein the compound of general formula (I) is selected from the group consisting of compounds (II) to (VII): 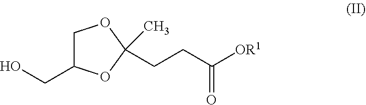
wherein R1 is methyl, ethyl, n-propyl or n-butyl; 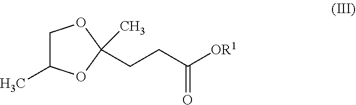
wherein R1 is methyl, ethyl, n-propyl or n-butyl; 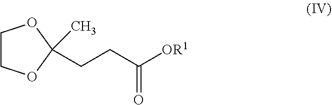
wherein R1 is methyl, ethyl, n-propyl or n-butyl; 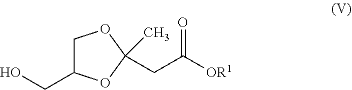
wherein R1 is methyl, ethyl n-propyl or n-butyl; 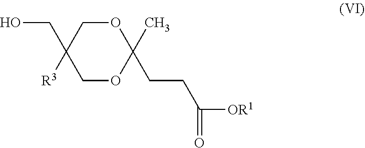
wherein R1 is methyl, ethyl, n-propyl or n-butyl; and R3 is methyl or ethyl; and 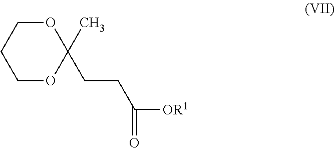
wherein R1 is methyl, ethyl, n-propyl or n-butyl.

3. The composition according to claim 1, wherein the compound is selected from the group consisting of
ethyl propylene glycol acetal levulinate: 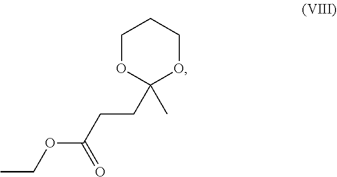
ethyl glycerine acetal levulinate: 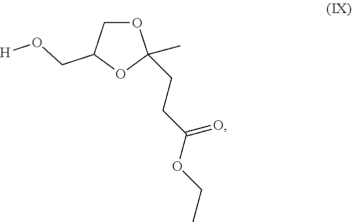
butyl-3-(2,4-dimethyl-1,3-dioxolan-2-yl-)propanoate: 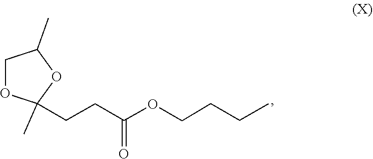 [SMILES: CCCCOC(=O)CCC1(C)OCC(C)O1]
and mixtures thereof.

4. The composition according to claim 1, wherein the at least one antimicrobial component (a) is selected from the group consisting of o-Cymen-5-ol, Isopropylparaben, Capryloyl Glycine, Phenylpropanol, Tropolone, PCA Ethyl Cocoyl Arginate, 2-Methyl-5-Cyclohexylpentanol, Phenoxyethanol, Disodium EDTA, Methylparaben and its salts, Caprylhydroxamic Acid, Sodium Benzoate, Benzyl Alcohol, Potassium Sorbate, Benzyl Salicylate, Methylbenzyl Alcohol, Propylparaben, Methylchloroisothiazolinone, Methylisothiazolinone, Ethylhexylglycerin, Butylparaben, Ethylparaben, Sodium Propylparaben, DMDM Hydantoin, Dehydroacetic Acid, Iodopropynyl Butylcarbamate, Salicylic Acid, Chlorphenesin, Isobutylparaben, Sodium Ethylparaben, Diazolidinyl Urea, Farnesol, Bisabolol, Sodium Phytate or Phytic Acid, Sodium Levulinate or Levulinic Acid, Chlorhexidine, Glyceryl Laurate, Anisic Acid and its salts, Chlorhexidine Digluconate, TEA-salicylate, Phenethyl Alcohol, Hexylene Glycol, Glyceryl Caprate, Sorbitan Caprylate, Tetrasodium Glutamate Diacetate, Trisodium Ethylenediamine Disuccinate, Hydroxyethoxyphenyl Butanone, Hydroxyethoxyphenyl Butanol, Itaconic Acid, Octopirox, Propanediol Caprylate, Climbazole, Undecylenoyl Glycine, Undecylenic Acid, Thymol, Glyceryl Caprylate, 4-Hydroxyacetophenone, Sodium Lactate, Trisodium Dicarboxymethyl Alaninate, 1,3-propanediol, 1,2-pentanediol, 1,2-hexanediol, 1,2-heptanediol, 1,2-octanediol, 1,2-nonanediol, 1,2-decanediol, 2,3-pentanediol, 2,3-hexanediol, 2,3-heptanediol 2,3-octanediol, 2,3-nonanediol, 2,3-decanediol, and mixtures of two or more the aforesaid antimicrobial agents.

5. The composition according to claim 1, further comprising at least one antimicrobial agent, which is different from the antimicrobial component (a), which is selected from the group consisting of 2-benzylheptanol, alkyl (C 12-22) trimethyl ammonium bromide and chloride, ascorbic acid and salts therof, benzalkonium bromide, benzalkonium chloride, benzalkonium saccharinate, benzethonium chloride, Benzoic Acid, camphor, cetylpyridinium chloride, chlorhexidine diacetate, chlorhexidine dihydrochloride, chlorocresol, chloroxylenol, Cyclohexylglycerin, Dimethyl phenylbutanol, Dimethyl phenylpropanol, ethanol, ethyl lauroyl arginate HCl, Ethyl Lauroyl Arginate Laurate, eucalyptol, gluconic acid and salts thereof, glycerin, hexamidine, hexamidine diisethionate, Hexylglycerin, Iodopropynyl Butylcarbamate, jasmol, lauryl alcohol, Levulinic Acid, mannitol, menthol, methyl salicylate, Octenidine HCl, polyarginine, Polyglyceryl-10 Laurate, polyglyceryl-2 caprate, Polyglyceryl-3 caprylate, polylysine, Salvia Officinalis (Sage) Oil, silver chloride, silver citrate, sodium caproyl lactylate, Sodium Caproyl/Lauroyl Lactylate, sodium lauroyl lactylate, Sorbic Acid, sorbitol, Tetraselmis extract, triclocarban, triclosan, Triethyl citrate, Xylityl Sesquicaprylate, zinc citrate, zinc pyrithione, Zinc ricinoleate, and mixtures of two or more of the aforesaid antimicrobial agents.

6. The composition according to claim 1, wherein the at least one active substance for food, a cosmetic or pharmaceutical composition or a home care product is selected from the group consisting of agents against ageing of the skin, antioxidants, chelating agents, emulsifiers, surfactants, green and synthetic polymers, skin-cooling agents, rheology additives, oils, fragrances or perfume oils, polyols, and mixtures of two or more of the afore-mentioned substances.

7. The composition according to claim 1, comprising the antimicrobial component (a) in an amount of 0.01 to 25.0% by weight, based on the total weight of the composition.

8. The composition according to claim 1, comprising the alkyl ketal ester compound (b) in an amount of 0.001 to 15.0% by weight, based on the total weight of the composition.

9. An antimicrobial compound represented by the general formula (I) 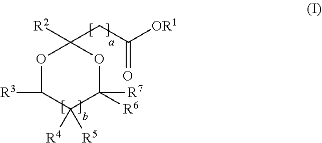
wherein
R1 is an optionally substituted C1 to C12 alkyl or an optionally substituted C1 to C12 alkenyl;
R2 is hydrogen, an optionally substituted C1 to C3 alkyl or an optionally substituted C1 to C3 alkenyl;
R3, R4, R5, R6 and R7 are each independently hydrogen, an optionally substituted C1 to C6 alkyl or an optionally substituted C1 to C6 alkenyl;
a is 0 or an integer of 1 to 6;
b is 0 or 1;
or derivatives thereof.

10. The antimicrobial compound according to claim 9, wherein the compound is selected from the group consisting of
ethyl propylene glycol acetal levulinate: 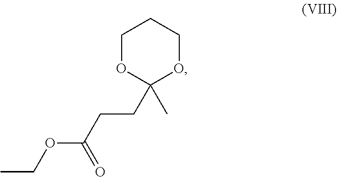
ethyl glycerine acetal levulinate: 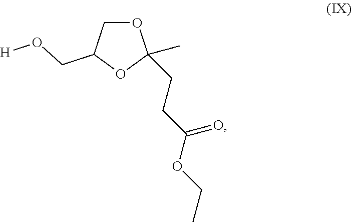
butyl-3-(2,4-dimethyl-1,3-dioxolan-2-yl-)propanoate: 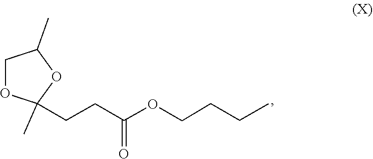 [SMILES: CCCCOC(=O)CCC1(C)OCC(C)O1]
and mixtures thereof.

11. A food, cosmetic or pharmaceutical preparation or home care product comprising a composition according to claim 1.

12. The cosmetic or pharmaceutical preparation according to claim 11, wherein the cosmetic or pharmaceutical preparation is
i. in the form of a dispersion comprising an oil component in an amount of ≥1% by weight;
ii. in the form of a liquid surfactant formulation;
iii. in the form of a solid surfactant formulation; or
iv. in the form of an aqueous or aqueous/alcoholic, solution or an aqueous/glycolic solution.

13-14. (canceled)

15. A method for boosting the efficacy of an antimicrobial component in a food, a cosmetic or pharmaceutical composition, or a home care product comprising incorporating into the food, cosmetic or pharmaceutical composition, or home care product a composition comprising the compound of claim 9.

16. A method for suppressing or inhibiting microorganism growth in food, a cosmetic or a pharmaceutical preparation, or a home care product comprising the steps of:
providing a food, cosmetic or pharmaceutical preparation or a home care product;
incorporating therein an effective amount of an antimicrobial composition as defined in claim 1.

17. The composition according to claim 7 comprising the antimicrobial component (a) in an amount of 0.05 to 6.0% by weight, based on the total weight of the composition.

18. The composition according to claim 8 wherein the alkyl ketal ester compound (b) is ethyl propylene glycol acetal levulinate, ethyl glycerine acetal levulinate, or butyl-3-(2,4-dimethyl-1,3-dioxolan-2-yl-)propanoate.

19. The composition according to claim 8 comprising the alkyl ketal ester compound (b) in an amount of 0.1 to 5.0% by weight, based on the total weight of the composition

20. The method according to claim 16, wherein the microorganisms are selected from the group consisting of the genus Pseudomonas, Staphylococcus, Escherichia, Candida, Aspergillus, and combinations thereof.

21. The method according to claim 20, wherein the microorganisms are selected from the group consisting of Pseudomonas aeruginosa, Staphylococcus aureus, Escherichia coli, Candida albicans, and Aspergillus brasiliensis, and combinations thereof.

22. The cosmetic or pharmaceutical preparation according to claim 12 wherein the cosmetic or pharmaceutical preparation is in the form of a dispersion, and wherein the dispersion is an emulsion.
